(19) United States
(12) Patent Application Publication
(10) Pub. No.: US 2025/0267667 A1
(43) Pub. Date: Aug. 21, 2025

(54) METHOD AND APPARATUS FOR TRANSMITTING UPLINK CONTROL CHANNEL IN WIRELESS COMMUNICATION SYSTEM

(71) Applicant: Samsung Electronics Co., Ltd., Suwon-si, Gyeonggi-do (KR)

(72) Inventors: Jaeyeon SHIM, Suwon-si (KR); Kyungjun CHOI, Suwon-si (KR); Seongmok LIM, Suwon-si (KR); Youngrok JANG, Suwon-si (KR); Hyoungju JI, Suwon-si (KR)

(21) Appl. No.: 18/858,501

(22) PCT Filed: Apr. 19, 2023
(86) PCT No.: PCT/KR2023/005328

§ 371 Date: Oct. 21, 2024

(30) Foreign Application Priority Data
Apr. 29, 2022 (KR) 10-2022-0053195

(51) Int. Cl. H04W 72/21; H04L 5/00; H04L 5/14

(52) U.S. Cl. CPC H04W 72/21; H04L 5/0012; H04L 5/14

(57) ABSTRACT

The present disclosure relates to a 5G or 6G communication system for supporting a higher data transmission rate. The present disclosure describes a method and apparatus for a terminal to determine a PUCCH transmission location in a frequency domain in an SBFD environment. The method performed by the terminal in a wireless communication system comprises the steps of: receiving subband non-overlapping full duplex (SBFD) configuration information from a base station, the SBFD configuration information including uplink subband configuration information; identifying a physical uplink control channel (PUCCH) resource on the basis of an uplink subband, which is based on the uplink subband configuration information, and an initial uplink bandwidth part (BWP); and transmitting uplink control information in the PUCCH resource.

### TECHNICAL FIELD

The disclosure relates to operations of a terminal and a base station in a wireless communication system. Specifically, the disclosure relates to a method for performing transmission of a physical uplink control channel by a terminal supporting subband non-overlapping full duplex (SBFD) and an apparatus capable of performing the same.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to smoothly provide these services.

### DISCLOSURE OF INVENTION

### Technical Problem

Based on the above discussion, the disclosure provides an apparatus and a method that can effectively provide services in a mobile communication system. In particular, the disclosure provides an apparatus and a method in which a terminal and a base station transmits and receives uplink control information effectively according to an SBFD scheme.

### Solution to Problem

To solve the above problems, the disclosure provides a method performed by a terminal in a wireless communication system, the method including receiving subband non-overlapping full duplex (SBFD) configuration information from a base station, the SBFD configuration information including uplink subband configuration information, identifying a physical uplink control channel (PUCCH) resource, based on an uplink subband, which is based on the uplink subband configuration information, and an initial uplink bandwidth part (BWP), and transmitting uplink control information in the PUCCH resource.

In addition, a method performed by a base station in a wireless communication system includes receiving subband non-overlapping full duplex (SBFD) configuration information from a terminal, the SBFD configuration information including uplink subband configuration information, and receiving uplink control information in a physical uplink control channel (PUCCH) resource, wherein the PUCCH resource is associated with an initial uplink bandwidth part (BWP) and an uplink subband according to the uplink subband configuration information.

In addition, a terminal in a wireless communication system includes a transceiver, and a controller configured to perform control to receive subband non-overlapping full duplex (SBFD) configuration information from a base station, the SBFD configuration information including uplink subband configuration information, identify a physical uplink control channel (PUCCH) resource, based on an uplink subband, which is based on the uplink subband configuration information, and an initial uplink bandwidth part (BWP), and transmit uplink control information in the PUCCH resource.

In addition, a base station in a wireless communication system includes a transceiver, and a controller configured to perform control to receive subband non-overlapping full duplex (SBFD) configuration information from a terminal, the SBFD configuration information including uplink subband configuration information, and receive uplink control information in a physical uplink control channel (PUCCH) resource, wherein the PUCCH resource is associated with an initial uplink bandwidth part (BWP) and an uplink subband according to the uplink subband configuration information.

### Advantageous Effects of Invention

An apparatus and a method according to embodiments of the disclosure can effectively provide services in a mobile communication system. In particular, a terminal and a base station according to the SBFD scheme can effectively transmit and receive uplink control information according to embodiments of the disclosure.

### BRIEF DESCRIPTION OF DRAWINGS

FIG. 1 illustrates a basic structure of a time-frequency domain in a wireless communication system according to an embodiment of the disclosure.

FIG. 2 illustrates a structure of s frame, a subframe, and a slot in a wireless communication system according to an embodiment of the disclosure.

FIG. 3 illustrates an example of bandwidth part configuration in a wireless communication system according to an embodiment of the disclosure.

FIG. 4 illustrates an example of control resource set (CORESET) configuration of a downlink control channel in a wireless communication system according to an embodiment of the disclosure.

FIG. 5 illustrates a structure of a downlink control channel in a wireless communication system according to an embodiment of the disclosure.

FIG. 6 illustrates an example in which a base station and a UE transmit/receive data in consideration of a downlink data channel and a rate matching resource in a wireless communication system according to an embodiment of the disclosure.

FIG. 7 illustrates an example of frequency domain resource allocation with regard to a physical downlink shared channel (PDSCH) in a wireless communication system according to an embodiment of the disclosure.

FIG. 8 illustrates an example of time domain resource allocation with regard to a PDSCH in a wireless communication system according to an embodiment of the disclosure.

FIG. 9 illustrates an example of time domain resource allocation according to a subcarrier spacing with regard to a data channel and a control channel in a wireless communication system according to an embodiment of the disclosure.

FIG. 10 illustrates radio protocol structures of a base station and a UE in single cell, carrier aggregation, and dual connectivity situations in a wireless communication system according to an embodiment of the disclosure.

FIG. 11 illustrates an example of a method of determining the PUCCH resource.

FIG. 12 illustrates an example of a method of configuring an SBFD resource.

FIG. 13 illustrates an example of determining a PUCCH transmission resource location in a frequency domain of a UE during initial access.

FIG. 14 illustrates an SBFD configuration according to an embodiment.

FIG. 15 illustrates an example of a method of, based on a UL BWP, determining a PUCCH transmission location.

FIG. 16 illustrates an example of a method of, based on a UL subband, determining a PUCCH transmission location.

FIG. 17 illustrates an example of a method of determining a PUCCH transmission location in a region occupying a small bandwidth among a UL subband and a UL BWP.

FIG. 18 illustrates an example of a method of determining a PUCCH transmission-capable region, based on configuration information.

FIG. 19 illustrates another example of a method of determining a PUCCH transmission-capable region, based on configuration information.

FIG. 20 illustrates an example of a UE operation according to an embodiment of the disclosure.

FIG. 21 illustrates an example of a base station operation according to an embodiment of the disclosure.

FIG. 22 illustrates a structure of a UE in a wireless communication system according to an embodiment of the disclosure.

FIG. 23 illustrates a structure of a base station in a wireless communication system according to an embodiment of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and may also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

### [NR Time-Frequency Resources]

Hereinafter, a frame structure of a 5G system will be described in more detail with reference to the accompanying drawings.

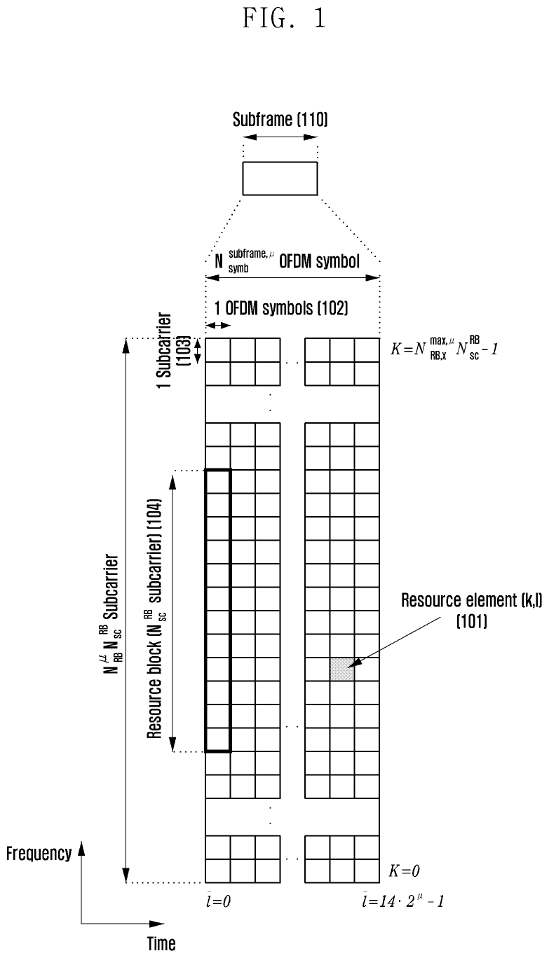

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104.

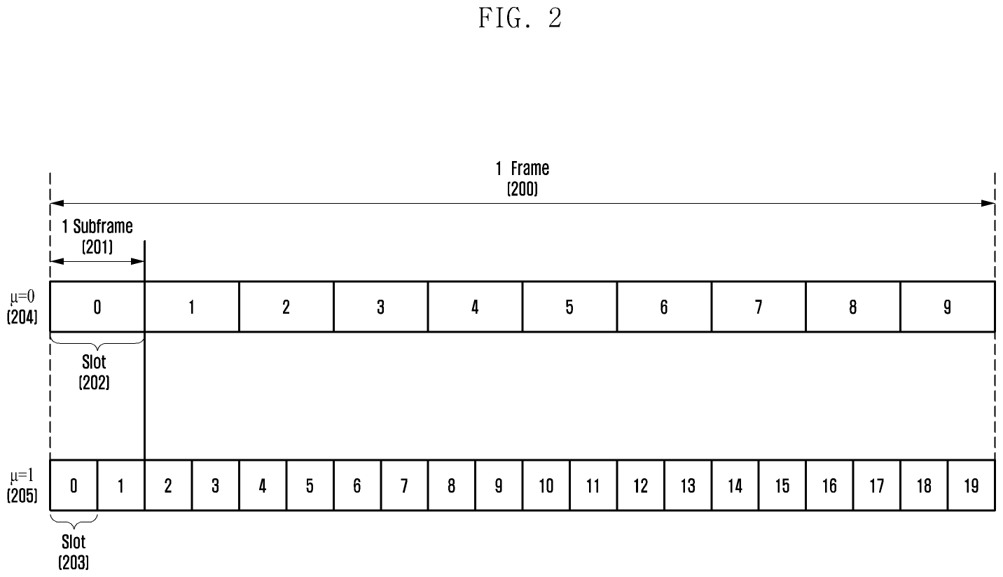

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values μ for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{sunframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, bandwidth part (BWP) configuration in a 5G communication system will be described in detail with reference to the accompanying drawings.

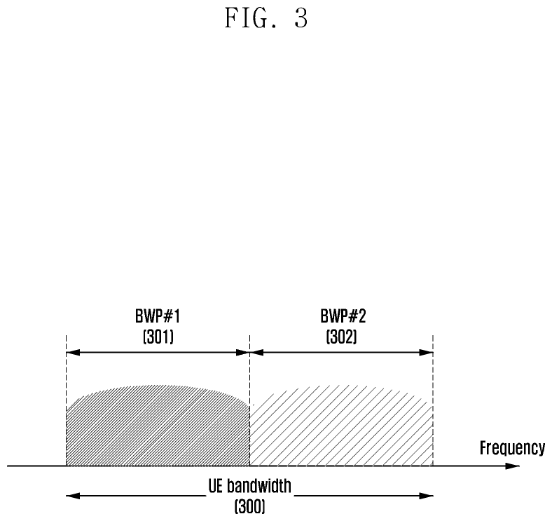

FIG. 3 illustrates an example of bandwidth part configuration in a wireless communication system according to an embodiment of the disclosure.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, |
| n3, n4, n5}, | |
| (subcarrier spacing) | |
| cyclicPrefix | ENUMERATED { extended |

}
(cyclic prefix)
}

Of course, the above example is not limiting, and in addition to the configuration information given above, various parameters related to the bandwidth part may be configured for the UE. The base station may transfer the configuration information to the UE through higher layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to some embodiments, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding CORESET #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by CORESET #0 acquired from the MIB is an initial bandwidth part for initial access. The ID of the initial bandwidth part may be considered to be 0.

The UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### [Bandwidth Part (BWP) Change]

If a UE has one or more bandwidth parts configured therefor, the base station may indicate, to the UE, to change (or switch or transition) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and thus, upon receiving a bandwidth part change request, the UE needs to be able to receive or transmit the PDSCH or PUSCH scheduled by the corresponding DCI in the changed bandwidth part with no problem. To this end, requirements for the delay time (T_{BWP}) required during a bandwidth part change are specified in standards, and may be defined given in Table 3 below, for example.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the bandwidth part change delay time support type 1 or type 2, depending on the capability of the UE. The UE may report the supportable bandwidth part change delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel, based on the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (for example, the last symbol of slot n+K−1).

### [SS/PBCH Block]

Next, synchronization signal/physical broadcast channel (SS/PBCH) blocks in 5G will be described.

An SS/PBCH block may refer to a physical layer channel block including a primary synchronization signal (PSS), a secondary synchronization signal (SSS), and a PBCH. Details thereof are as follows.
PSS: a signal which becomes a reference of downlink time/frequency synchronization, and provides partial information of a cell ID.
SSS: becomes a reference of downlink time/frequency synchronization, and provides remaining cell ID information not provided by the PSS. Additionally, the SSS may serve as a reference signal for PBCH demodulation of a PBCH.
PBCH: provides an MIB which is mandatory system information necessary for the UE to transmit/receive data channels and control channels. The essential system information may include search space-related control information indicating a control channel's radio resource mapping information, scheduling control information regarding a separate data channel for transmitting system information, and the like.
SS/PBCH block: the SS/PBCH block includes a combination of a PSS, an SSS, and a PBCH. One or multiple SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure control resource set (CORESET) #0 (which may correspond to a control resource set having a control resource set index of 0). The UE may monitor control resource set #0 by assuming that the demodulation reference signal (DMRS) transmitted in the selected SS/PBCH block and CORESET #0 are quasi-co-located (QCL). The UE may receive system information with downlink control information transmitted in CORESET #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and the fact that CORESET #0 associated therewith is monitored.

In general, the UE may establish a radio link to a network through a random access procedure, based on synchronization with the network and system information, acquired in a cell search process for the corresponding cell. As the random access, a contention-based scheme or a contention-free scheme may be used. If the UE performs cell selection and cell reselection in the initial access step, the contention-based scheme may be used, for example, in the case of transitioning from an RRC_IDLE (RRC idle) state to an RRC_CONNECTED (RRC connected) state, and for other purposes. The contention-free scheme may be used in order to reconfigure uplink synchronization in the case where downlink data reaches, in the case of handover, or in the case of location measurement.

### [PDCCH: Regarding DCI]

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through or on a physical downlink control channel (PDCCH). A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 4 below, for example.

TABLE 4

| | |
|---|---|
| - | Identifier for DCI formats - [1] bit |
| - | Frequency domain resource assignment - |

[┌log₂(N_{RB}^{UL,BWP} (N_{RB}^{UL,BWP} +1)/2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH - [2] |

bits

| | |
|---|---|
| - | Uplink/ supplementary uplink (UL/SUL) indicator - 0 or 1 bit |

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 5 below, for example.

TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
* For resource allocation type 0, ┌N_{RB}^{UL,BWP}/P┐ bits
* For resource allocation type 1, ┌1og₂ (N_{RB}^{UL,BWP}(N_{RB}^{UL,BWP} + 1)/2)┐
bits
- Time domain resource assignment - 1, 2, 3, or 4 bits
- Virtual resource block (VRB)-to-physical resource block (PRB)
mapping - 0 or 1 bit, only for resource allocation type 1.
* 0 bit if only resource allocation type 0 is configured;
* 1 bit otherwise.
- Frequency hopping flag - 0 or 1 bit, only for resource allocation type 1.
* 0 bit if only resource allocation type 0 is configured;
* 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
* 1 bit for semi-static HARQ-ACK codebook;
* 2 bits for dynamic HARQ-ACK codebook with single HARQ-ACK
codebook.
- 2nd downlink assignment index - 0 or 2 bits
* 2 bits for dynamic HARQ-ACK codebook with two HARQ-ACK sub-
codebooks;
* 0 bit otherwise.
- TPC command for scheduled PUSCH - 2 bits
- $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
* $⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$
* ┌log, (NsRS)┐ bits for codebook based PUSCH transmission.
- Precoding information and number of layers - up to 6 bits
- Antenna ports - up to 5 bits
- SRS request - 2 bits
- Channel state information (CSI) request - 0, 1, 2, 3, 4, 5, or 6 bits
- Code block group (CBG) transmission information - 0, 2, 4, 6, or 8
bits
- Phase tracking reference signal (PTRS)-demodulation reference signal
(DDMRS) association - 0 or 2 bits.
- beta offset indicator - 0 or 2 bits
- DMRS sequence initialization - 0 or 1 bit

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 6 below, for example.

TABLE 6

| | |
|---|---|
| - | Identifier for DCI formats - [1] bit |
| - | Frequency domain resource assignment - |

[┌log₂(N_{RB}^{DL,BWP} (N_{RB}^{DL,BWP} +1)/2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Pysical uplink control channel (PUCCH) resource indicator - 3 bits |
| - | PDSCH-to-HARQ feedback timing indicator - [3] bits |

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 7 below, for example.

TABLE 7

| - | Carrier indicator - 0 or 3 bits |
|---|---|
| - | Identifier for DCI formats - [1] bits |
| - | Bandwidth part indicator - 0, 1 or 2 bits |
| - | Frequency domain resource assignment |
| * For resource allocation type 0, ┌N_{RB}^{DL,BWP} / P┐ bits | |
| * For resource allocation type 1, ┌log₂(N_{RB}^{DL,BWP} (N_{RB}^{DL,BWP} | |
| +1)/2┐ bits | |
| - | Time domain resource assignment -1, 2, 3, or 4 bits |
| - | VRB-to-PRB mapping - 0 or 1 bit, only for resource |
| | allocation type 1. |
| * 0 bit if only resource allocation type 0 is configured; | |
| * 1 bit otherwise. | |
| - | Physical resource block (PRB) bundling size indicator - |
| | 0 or 1 bit |
| - | Rate matching indicator - 0, 1, or 2 bits |
| - | Zero power (ZP) channel state information (CSI)-reference |
| | signal (RS) |
| trigger - 0, 1, or 2 bits | |
| For transport block 1: | |
| - | Modulation and coding scheme - 5 bits |
| - | New data indicator - 1 bit |
| - | Redundancy version - 2 bits |
| For transport block 2: | |
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, and Search Space]

Hereinafter, a downlink control channel in a 5G communication system will be described in more detail with reference to the accompanying drawings.

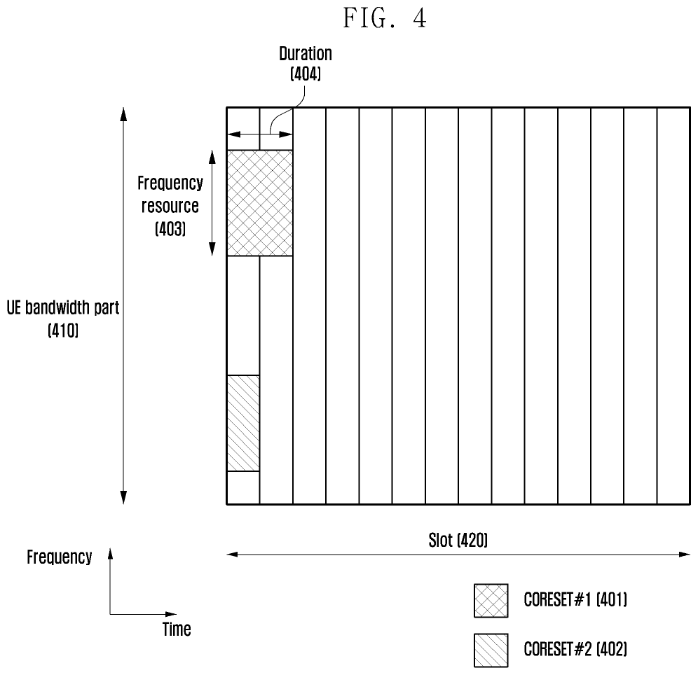

FIG. 4 illustrates an example of a CORESET used to transmit a downlink control channel in a wireless communication system. FIG. 4 illustrates an example in which a UE bandwidth part 410 is configured along the frequency axis, and two CORESETs (CORESET #1 420 and CORESET #2 401) are configured within one slot 402 along the time axis. The CORESETs 401 and 402 may be configured in a specific frequency resource 410 within the entire UE bandwidth part 403 along the frequency axis. One or multiple OFDM symbols may be configured along the time axis, and this may be defined as a control resource set duration 404. Referring to the example illustrated in FIG. 4, CORESET #1 401 is configured to have a CORESET duration of two symbols, and CORESET #2 402 is configured to have a CORESET duration of one symbol.

A control resource set in 5G described above may be configured for a UE by a base station through higher layer signaling (for example, system information, master information block (MIB), radio resource control (RRC) signaling). The description that a CORESET is configured for a UE means that information such as the identity of a CORESET, the frequency location of a CORESET, and the symbol duration of a CORESET is provided. For example, the CORESET configuration information may include the following pieces of information: given in Table 8 below.

TABLE 8

| ConControlResourceSet ::= | SEQUENCE { |
|---|---|
| -- Corresponds to L1 parameter ‘CORESET-ID’ | |
| controlResourceSetId | |
| ControlResourceSetId, | |
| (control resource set identity) | |
| frequencyDomainResources | BIT STRING (SIZE |
| (45)), | |
| (frequency domain resource assignment information) | |
| duration | INTEGER |
| (1..maxCoReSetDuration), | |
| (time domain resource assignment information) | |
| cce-REG-MappingType | |
| CHOICE { | |
| (CCE-to-REG mapping type) | |
| interleaved | |
| SEQUENCE { | |
| reg-BundleSize | |
| ENUMERATED {n2, n3, n6}, | |
| (REG bundle size) | |
| precoderGranularity | |
| ENUMERATED {sameAsREG-bundle, allContiguousRBs}, | |
| interleaverSize | |
| ENUMERATED {n2, n3, n6} | |
| (interleaver size) | |
| shiftIndex | |
| INTEGER(0..maxNrofPhysicalResourceBlocks-1) | |
| OPTIONAL | |
| (interleaver shift) | |
| }, | |
| nonInterleaved | NULL |
| }, | |
| tci-StatesPDCCH | |
| SEQUENCE(SIZE (1..maxNrofTCI-StatesPDCCH)) OF TCI-StateId | |
| OPTIONAL, | |
| (QCL configuration information) | |
| tci-PresentInDCI | ENUMERATED |

{enabled}
}

In Table 8, tci-StatesPDCCH (simply referred to as transmission configuration indication (TCI) state) configuration information may include information of one or multiple SS/PBCH block indexes or channel state information reference signal (CSI-RS) indexes, which are quasi-co-located (OCLed) with a DMRS transmitted in a corresponding CORESET.

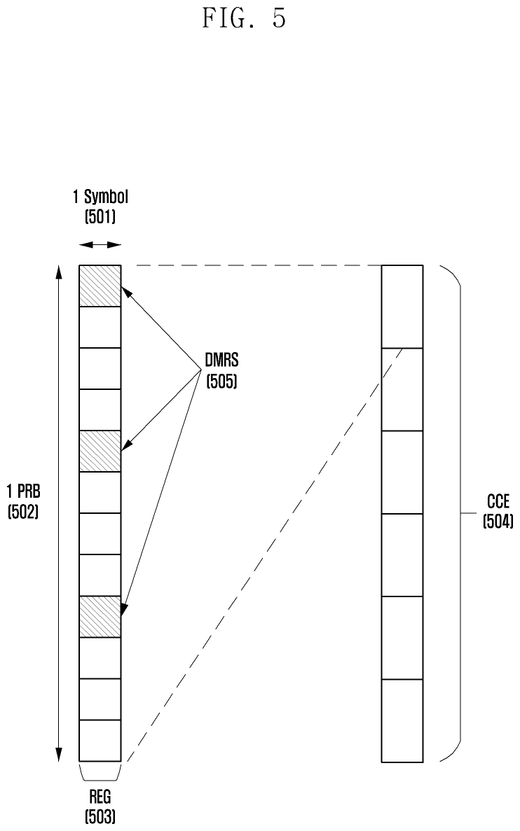

FIG. 5 illustrates an example of a basic unit of time and frequency resources constituting a downlink control channel available in a 5G system. According to FIG. 5, the basic unit of time and frequency resources constituting a control channel may be referred to as a resource element group (REG) 503, and the REG 503 may be defined by one OFDM symbol 501 along the time axis and one physical resource block (PRB) 502, that is, 12 subcarriers, along the frequency axis. The base station may configure a downlink control channel allocation unit by concatenating the REGs 503.

Provided that the basic unit of downlink control channel allocation in 5G is a control channel element % n as illustrated in FIG. 5, one CCE % n may include multiple REGs % n. To describe the REG 503 illustrated in FIG. 5, for example, the REG 503 may include 12 REs, and if one CCE 504 includes six REGs 503, one CCE 504 may then include 72 REs. A downlink control resource set, once configured, may include multiple CCEs 504, and a specific downlink control channel may be mapped to one or multiple CCEs 504 and then transmitted according to the aggregation level (AL) in the control resource set. The CCEs 504 in the CORESET are distinguished by numbers, and the numbers of CCEs 504 may be allocated according to a logical mapping scheme.

The basic unit of the downlink control channel illustrated in FIG. 5, that is, the REG 503, may include both REs to which DCI is mapped, and an area to which a reference signal (DMRS 505) for decoding the same is mapped. As in FIG. 5, three DRMSs 503 may be transmitted inside one REG 505. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the base station through higher layer signaling (for example, SIB, MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a CORESET index for monitoring the search space, and the like. For example, the search space configuration information may include the following pieces of information: given in Table 9 below.

TABLE 9

| | |
|---|---|
| SearchSpace ::= | SEQUENCE { |

```
    -- Identity of the search space. SearchSpaceId = 0 identifies the SearchSpace
configured via PBCH (MIB) or ServingCellConfigCommon.
    searchSpaceId
    SearchSpaceId,
  (search space identity)
    controlResourceSetId
    ControlResourceSetId,
  (control resource set identity)
```

| | |
|---|---|
| monitoringSlotPeriodicityAndOffset | CHOICE { |

```
  (monitoring slot level periodicity)
      sl1
    NULL,
      sl2
    INTEGER (0..1),
      sl4
    INTEGER (0..3),
      sl5
    INTEGER (0..4),
      sl8
    INTEGER (0..7),
      sl10
    INTEGER (0..9),
      sl16
    INTEGER (0..15),
      sl20
    INTEGER (0..19)
    }
          OPTIONAL,
```

| | |
|---|---|
| duration (monitoring duration) | INTEGER (2..2559) |
| monitoringSymbolsWithinSlot | BIT STRING |

```
(SIZE (14))
      OPTIONAL,
  (monitoring symbols within slot)
```

| | |
|---|---|
| nrofCandidates | SEQUENCE { |

```
  (number of PDCCH candidates for each aggregation level)
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
```

| | |
|---|---|
| searchSpaceType | CHOICE { |

```
    (search space type)
      -- Configures this search space as common search space (CSS) and DCI
formats to monitor.
      common
    SEQUENCE {
    (common search space)
    }
      ue-Specific
    SEQUENCE {
    (UE-specific search space)
        -- Indicates whether the UE monitors in this USS for DCI
formats 0-0 and 1-0 or for formats 0-1 and 1-1.
        formats
    ENUMERATED {formats0-0-And-1-0, formats0-1-And-1-1},
    ...
}
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI Enumerated RNTIs may follow the definition and usage given below.

Cell RNTI (C-RNTI): used to schedule a UE-specific PDSCH

Temporary cell RNTI (TC-RNTI): used to schedule a UE-specific PDSCH

Configured scheduling RNTI (CS-RNTI): used to schedule a semi-statically configured UE-specific PDSCH

Random access RNTI (RA-RNTI): used to schedule a PDSCH in a random access step

Paging RNTI (P-RNTI): used to schedule a PDSCH in which paging is transmitted

System information RNTI (SI-RNTI): used to schedule a PDSCH in which system information is transmitted

Interruption RNTI (INT-RNTI): used to indicate whether a PDSCH is punctured

Transmit power control for PUSCH RNTI (TPC-PUSCH-RNTI): used to indicate a power control command regarding a PUSCH

Transmit power control for PUCCH RNTI (TPC-PUCCH-RNTI): used to indicate a power control command regarding a PUCCH

Transmit power control for SRS RNTI (TPC-SRS-RNTI): used to indicate a power control command regarding an SRS

The DCI formats enumerated above may follow the definitions given in Table 10 below, for example.

TABLE 10

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and |
| | PUSCH |
| 2_3 | Transmission of a group of TPC commands for |
| | SRS transmissions by one or more UEs |

In 5G, the search space at aggregation level L in connection with CORESET p and search space set s may be expressed by Equation 1 below.

$$L \cdot \{ ( {y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1
Y_{p,n}_{_{s,f}}^{μ}=(Aₚ·Y_{p,n}_{_{s,f}}^{μ}₋₁)mod D, Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The Y_{p,n}_{_{s,f}}^{μ} value may correspond to 0 in the case of a common search space.

The Y_{p,n}_{_{s,f}}^{μ} value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### [Regarding Rate Matching/Puncturing]

Hereinafter, a rate matching operation and a puncturing operation will be described in detail.

If time and frequency resource A to transmit symbol sequence A overlaps time and frequency resource B, a rate matching or puncturing operation may be considered as an operation of transmitting/receiving channel A in consideration of resource C (region in which resource A and resource B overlap). Specific operations may follow the following description.

### Rate Matching Operation

The base station may transmit channel A after mapping the same only to remaining resource domains other than resource C (region overlapping resource B) among the entire resource A which is to be used to transmit symbol sequence A to the UE. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may send symbol sequence A after successively mapping the same to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C. The UE may receive symbol sequence A, based on an assumption that symbol sequence A has been mapped and transmitted in the remaining region other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that the same has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource region corresponding to resource C, and may perform transmission with regard to only the remaining resource region other than resource C among resource A. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may map symbol sequence {symbol #1, symbol #2, symbol #3, symbol #4} to resource A {resource #1, resource #2, resource #3, resource #4}, respectively, may transmit only symbol sequence {symbol #1, symbol #2, symbol #4} corresponding to remaining resources {resource #1, resource #2, resource #4} other than {resource #3} (corresponding to resource C) among resource A, and may not transmit {symbol #3} mapped to {resource #3} (corresponding to resource C). Consequently, the base station may transmit symbol sequence {symbol #1, symbol #2, symbol #4} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence A, based on an assumption that symbol sequence A has been mapped to the entire resource A but transmitted only in the remaining region other than resource C among the resource region A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted, and based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive the same. Consequently, the UE may perform a series of following receiving operations based on an assumption that symbol sequence {symbol #1, symbol #2, symbol #4} has been transmitted after being mapped to {resource #1, resource #2, resource #4}, respectively.

Hereinafter, a method for configuring a rate matching resource for the purpose of rate matching in a 5G communication system will be described. Rate matching refers to adjusting the size of a signal in consideration of the amount of resources that can be used to transmit the signal. For example, data channel rate matching may mean that a data channel is not mapped and transmitted with regard to specific time and frequency resource domains, and the size of data is adjusted accordingly.

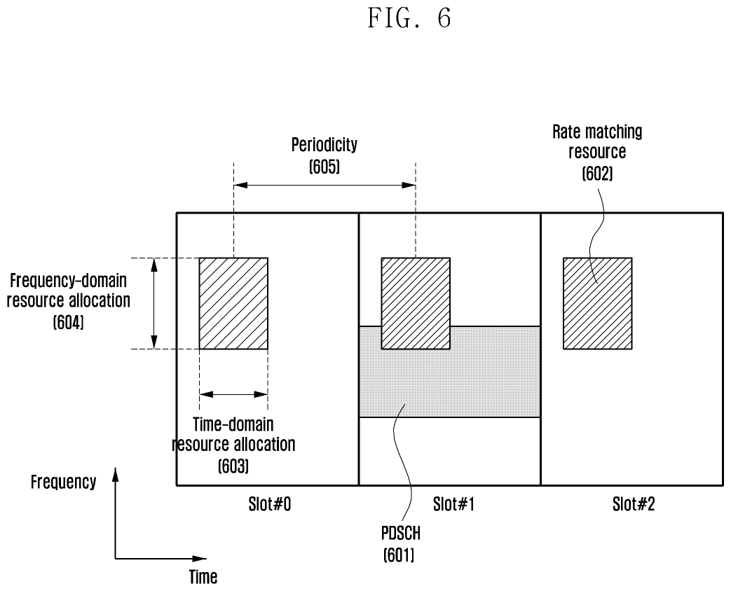

FIG. 6 is a diagram for explaining a method in which a base station and a UE transmit/receive data in consideration of a downlink data channel and a rate matching resource.

FIG. 6 illustrates a downlink data channel (PDSCH) 601 and a rate matching resource 602. The base station may configure one or multiple rate matching resources 602 for the UE through higher layer signaling (for example, RRC signaling). Rate matching resource 602 configuration information may include time-domain resource allocation information 603, frequency-domain resource allocation information 604, and periodicity information 605. A bitmap corresponding to the frequency-domain resource allocation information 604 will hereinafter be referred to as “first bitmap”, a bitmap corresponding to the time-domain resource allocation information 603 will be referred to as “second bitmap”, and a bitmap corresponding to the periodicity information 605 will be referred to as “third bitmap”. If all or some of time and frequency resources of the scheduled PDSCH 601 overlap a configured rate matching resource 602, the base station may rate-match and transmit the PDSCH 602 in a rate matching resource 601 part, and the UE may perform reception and decoding after assuming that the PDSCH 602 has been rate-matched in a rate matching resource 601 part.

The base station may dynamically notify the UE, through DCI, of whether the PDSCH will be rate-matched in the configured rate matching resource part through an additional configuration (for example, corresponding to “rate matching indicator” inside DCI format described above). Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, in a case where rate matching is to be conducted, the base station may indicate this case by “1”, and in a case where rate matching is not to be conducted, the base station may indicate this case by “0”.

5G supports granularity of “RB symbol level” and “RE level” as a method for configuring the above-described rate matching resources for a UE. More specifically, the following configuration method may be followed.

### RB Symbol Level

The UE may have a maximum of four RateMatchPatterns configured per each bandwidth part through higher layer signaling, and one RateMatchPattern may include the following contents.
may include, in connection with a reserved resource inside a bandwidth part, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.
may include a resource region corresponding to a time domain pattern configured by time and frequency domain resource regions configured by a CORESET inside a bandwidth part and a search space configuration in which corresponding resource regions are repeated.

### RE Level

The UE may have the following contents configured through higher layer signaling.
configuration information (Ite-CRS-ToMatchAround) regarding a RE corresponding to a LTE CRS (Cell-specific Reference Signal or common reference signal) pattern, which may include LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, subframe configuration information (mbsfn-SubframConfigList) corresponding to a multicast-broadcast single-frequency network (MBSFN), and the like. The UE may determine the position of the CRS inside the NR slot corresponding to the LTE subframe, based on the above-mentioned pieces of information.
may include configuration information regarding a resource set corresponding to one or multiple zero power (ZP) CSI-RSs inside a bandwidth part.

### [Regarding LTE CRS Rate Match]

Next, a rate matching process regarding the above-mentioned LTE CRS will be described in detail. For coexistence between LTE and NR, NR provides an NR UE with a function for configuring the pattern of a CRS of LTE. More specifically, the CRS pattern may be provided by RRC signaling including at least one parameter inside ServingCellConfig IE (information element) or ServingCellConfigCommon IE. Examples of the parameter may include Ite-CRS-ToMatchAround, Ite-CRS-PatternList1-r16, Ite-CRS-PatternList2-r16, crs-RateMatch-PerCORESETPoolIndex-r16, and the like.

Rel-15 NR provides a function by which one CRS pattern can be configured per serving cell through parameter lte-CRS-ToMatchAround. In Rel-16 NR, the above function has been expanded such that multiple CRS patterns can be configured per serving cell. More specifically, a UE having a single-transmission and reception point (TRP) configuration may now have one CRS pattern configured per one LTE carrier, and a UE having a multi-TRP configuration may now have two CRS patterns configured per one LTE carrier. For example, the UE having a single-TRP configuration may have a maximum of three CRS patterns configured per serving cell through parameter lte-CRS-PatternList1-r16. As another example, the UE having a multi-TRP configuration may have a CRS configured for each TRP. That is, the CRS pattern regarding TRP1 may be configured through parameter lte-CRS-PatternList1-r16, and the CRS pattern regarding TRP2 may be configured through parameter lte-CRS-PatternList2-r16. If two TRPs are configured as above, whether the CRS patterns of TRP1 and TRP2 are both to be applied to a specific physical downlink shared channel (PDSCH) or only the CRS pattern regarding one TRP is to be applied is determined through parameter crs-RateMatch-PerCORESETPoolIndex-r16, wherein if parameter crs-RateMatch-PerCORESETPoolIndex-r16 is configured “enabled”, only the CRS pattern of one TRP is applied, and both CRS patterns of the two TRPs are applied in other cases.

Table 11 shows a ServingCellConfig IE including the CRS patterns, and Table 12 shows a RateMatchPatternLTE-CRS IE including at least one parameter regarding CRS patterns.

TABLE 11

| | |
|---|---|
| ServingCellConfig ::= | SEQUENCE { |

```
  ...,
  [[
```

| | |
|---|---|
| lte-CRS-ToMatchAround | SetupRelease { RateMatchPatternLTE-CRS } |

OPTIONAL, -- Need M

| | |
|---|---|
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| downlinkChannelBW-PerSCS-List | SEQUENCE (SIZE (1..maxSCSs)) OF SCS- |
| SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL- |
| ConfigDedicated-IAB-MT-r16 | OPTIONAL, -- Cond TDD_IAB |
| dormantBWP-Config-r16 | SetupRelease { DormantBWP-Config-r16 } |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |
| } | OPTIONAL, -- |

Cond AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M

| | |
|---|---|
| crs-RateMatch-PerCORESETPoolIndex-r16 | ENUMERATED {enabled} |

```
OPTIONAL, -- Need R
  ...
  ]]
}
```

TABLE 12
- RateMatchPatternLTE-CRS
The IE RateMatchPatternLTE-CRS is used to configure a pattern to rate match around
LTE CRS. See TS 38.214 [19], clause 5.1.4.2.
RateMatchPatternLTE-CRS information element
-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, |

spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) |

OF RateMatchPatternLTE-CRS
-- TAG-RATEMATCHPATTERNLTE-CRS-STOP
-- ASN1STOP
RateMatchPatternLTE-CRS [symbol] descriptions
- carrierBandwidthDL
BW of the LTE carrier in number of PRBs (see TS 38.214 [19], clause 5.1.4.2).
- carrierFreqDL
Center of the LTE carrier (see TS 38.214 [19], clause 5.1.4.2).
- mbsfn-SubframeConfigList
LTE MBSFN subframe configuration (see TS 38.214 [19], clause 5.1.4.2).
- nrofCRS-Ports
Number of LTE CRS antenna port to rate-match around (see TS 38.214 [19], clause
5.1.4.2).
- v-Shift
Shifting value v-shift in LTE to rate match around LTE CRS (see TS 38.214 [19], clause
5.1.4.2).

### [PDSCH: Regarding Frequency Resource Allocation]

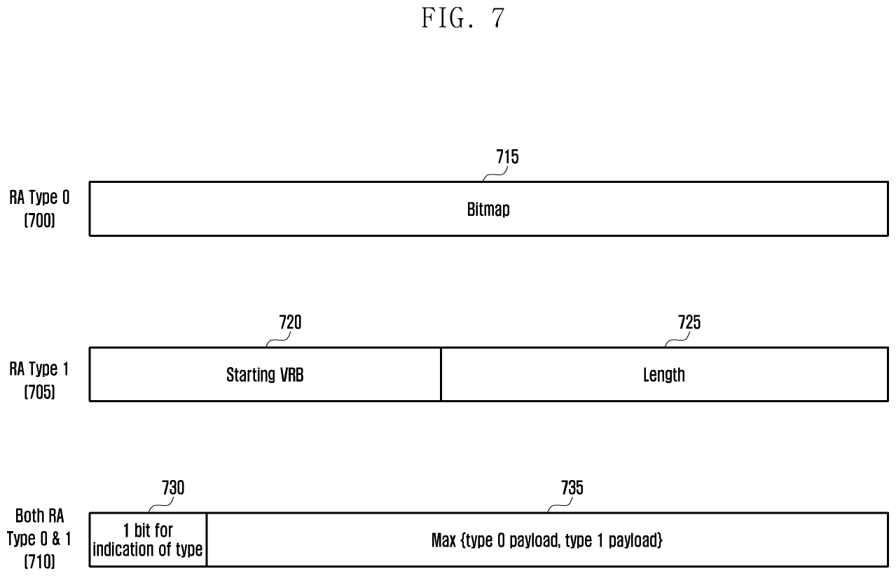

FIG. 7 illustrates an example of frequency domain resource allocation with regard to a PDSCH in a wireless communication system according to an embodiment of the disclosure.

FIG. 7 illustrates three frequency domain resource allocation methods of type 0 700, type 1 705, and dynamic switch 710 which can be configured through a higher layer in an NR wireless communication system.

Referring to FIG. 7, in the case in which a UE is configured to use only resource type 0 through higher layer signaling (700), partial downlink control information (DCI) for allocating a PDSCH to the UE include a bitmap including N_{RBG} bits. The conditions for this will be described again later. As used herein, N_{RBG} refers to the number of resource block groups (RBGs) determined according to the BWP size allocated by a BWP indicator and higher layer parameter rbg-Size, as in Table 19 below, and data is transmitted in RBGs indicated as “1” by the bitmap.

TABLE 13

| Bandwidth Part Size | Configuration 1 | Configuration 2 |
|---|---|---|
| 1-36 | 3 | 4 |
| 37-72 | 4 | 8 |
| 73-144 | 8 | 16 |
| 145-275 | 16 | 16 |

In case that the UE is configured to use only resource type 1 through higher layer signaling (705), some DCI for allocating PDSCHs to the UE includes frequency domain resource allocation information including bits. The conditions for this will be described again later. The base station may thereby configure a starting VRB 720 and the length 725 of a frequency domain resource allocated continuously therefrom.

In the case 710 in which the UE is configured to use both resource type 0 and resource type 1 through higher layer signaling, partial DCI for allocating a PDSCH to the corresponding UE includes frequency domain resource allocation information including as many bits as the larger value 735 between the payload 715 for configuring resource type 0 and the payload 720 and 725 for configuring resource type 1. The conditions for this will be described again later. One bit may be added to the foremost part (MSB) of the frequency domain resource allocation information inside the DCII, and if the bit has the value of “0”, use of resource type 0 may be indicated, and if the bit has the value of “1”, use of resource type 1 may be indicated.

### [PDSCH/PUSCH: Regarding Time Resource Allocation]

Hereinafter, a time domain resource allocation method regarding a data channel in a next-generation mobile communication system (5G or NR system) will be described.

A base station may configure a table for time domain resource allocation information regarding a physical downlink shared channel (PDSCH) and a physical uplink shared channel (PUSCH) for a UE through higher layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a timepoint at which a PDCCH is received and a timepoint at which a PDSCH scheduled by the received PDCCH is transmitted; labeled K0), PDCCH-to-PUSCH slot timing (for example, corresponding to a slot-unit time interval between a timepoint at which a PDCCH is received and a timepoint at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 14 or Table 15 below may be transmitted from the base station to the UE.

TABLE 14
PDSCH-TimeDomainResourceAllocationList information element

| | |
|---|---|
| PDSCH-TimeDomainResourceAllocationList ::= | SEQUENCE (SIZE(1..maxNrofDL- |

Allocations)) OF
PDSCH-TimeDomainResourceAllocation

| | |
|---|---|
| PDSCH-TimeDomainResourceAllocation ::= | SEQUENCE { |
| k0 | INTEGER(0..32) |

```
  OPTIONAL, -- Need S
      (PDCCH-to-PDSCH timing, slot unit)
```

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 15
PUSCH-TimeDomainResourceAllocationList information element

| | |
|---|---|
| PUSCH-TimeDomainResourceAllocationList ::= | SEQUENCE (SIZE(1..maxNrofUL- |

Allocations)) OF
PUSCH-TimeDomainResourceAllocation

| PUSCH-TimeDomainResourceAllocation ::= | SEQUENCE { | |
|---|---|---|
| k2 | INTEGER(0..32) | OPTIONAL, -- |

Need S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify the UF of one of the entries of the table regarding time domain resource allocation information described above through L1 signaling (for example, DCI) (for example, “time domain resource allocation” field in DCI may indicate the same). The UE may acquire time domain resource allocation information regarding a PDSCH or PUSCH, based on the DCI acquired from the base station.

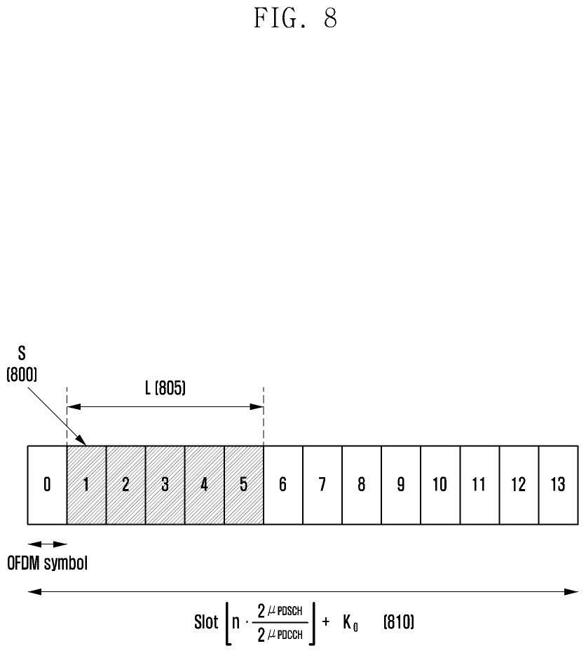

FIG. 8 illustrates an example of time domain resource allocation with regard to a PDSCH in a wireless communication system according to an embodiment of the disclosure.

Referring to FIG. 8, the base station may indicate the time domain location of a PDSCH resource according to the subcarrier spacing (SCS) (μ_{PDSCH}, μ_{PDCCH}) of a data channel and a control channel configured by using a higher layer, the scheduling offset (K0) value, and the OFDM symbol start location 800 and length 805 within one slot dynamically indicated through DCI.

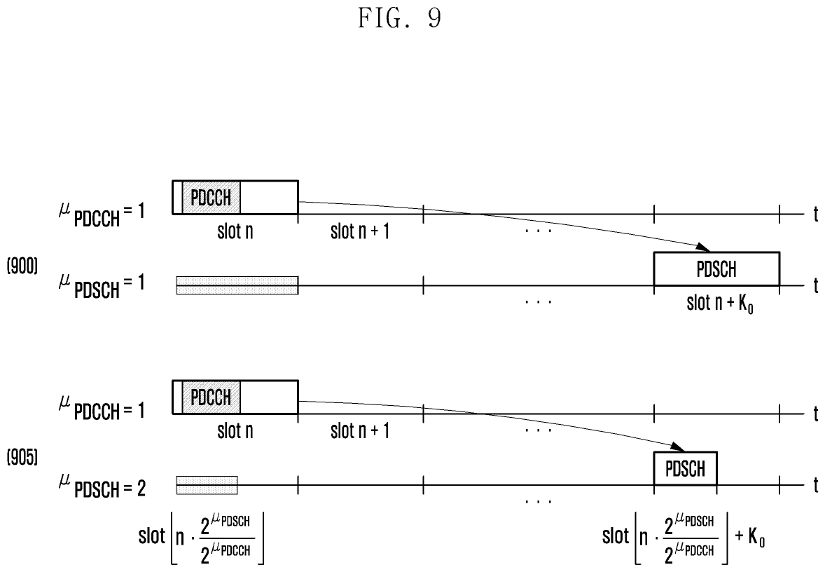

FIG. 9 illustrates an example of time domain resource allocation according to a subcarrier spacing with regard to a data channel and a control channel in a wireless communication system according to an embodiment of the disclosure.

Referring to FIG. 9, if the data channel and the control channel have the same subcarrier spacing (900, μ_{PDSCH}=μ_{PDCCH}), the slot number for data and that for control are identical, and the base station and the UE may accordingly generate a scheduling offset in conformity with a predetermined slot offset K0. On the other hand, if the data channel and the control channel have different subcarrier spacings (905, _{PUSCH}≠μ_{PDCCH}), the slot number for data and that for control are different, and the base station and the UE may accordingly generate a scheduling offset in conformity with a predetermined slot offset K0 with reference to the subcarrier spacing of the PDCCH.

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 16 through higher signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 16 through higher signaling. If PUSCH transmission is operated by a configured grant, parameters applied to the PUSCH transmission are applied through configuredGrantConfig (higher signaling) in Table 16 except for dataScramblingIdentityPUSCH, txConfig, codebookSubset, maxRank, and scaling of UCI-OnPUSCH, which are provided by pusch-Config (higher signaling) in Table 17. If provided with transformPrecoder inside configuredGrantConfig (higher signaling) in Table 16, the UE applies tp-pi2BPSK inside pusch-Config in Table 17 to PUSCH transmission operated by a configured grant.

TABLE 16

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14, sym2560x14,

sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

PathlossReferenceRSs−1),
...

| | |
|---|---|
| } | OPTIONAL, -- |

Need R
...
}

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 17, which is higher signaling, is “codebook” or “nonCodebook”.

As described above, PUSCH transmission may be dynamically scheduled through DCI format 0_0 or 0_1, and may be configured semi-statically by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 17, the UE does not expect scheduling through DCI format 0_1.

TABLE 17

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks−1)

OPTIONAL,

-- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | | |
|---|---|---|
| maxRank | INTEGER (1..4) | OPTIONAL, |

-- Cond codebookBased

| | | |
|---|---|---|
| rbg-Size | ENUMERATED { config2} | OPTIONAL, |

-- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (higher signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (higher signaling). The TPMI is used to indicate a precoder to be applied to PUSCH transmission. If one SRS resource is configured for the UE, the TPMI is used to indicate a precoder to be applied in the configured SRS resource. If multiple SRS resources are configured for the UE, the TPMI is used to indicate a precoder to be applied in an SRS resource indicated through the SRI.

The precoder to be used for PUSCH transmission may be selected from an uplink codebook having the same number of antenna ports as the value of nrofSRS-Ports inside SRS-Config (higher signaling). In connection with codebook-based PUSCH transmission, the UE determines a codebook subset, based on codebookSubset inside pusch-Config (higher signaling) and TPMI. The codebookSubset inside pusch-Config (higher signaling) may be configured to be one of “fully AndPartialAndNonCoherent”, “partialAndNonCoherent”, or “noncoherent”, based on UE capability reported by the UE to the base station. If the UE reported “partialAndNonCoherent” as UE capability, the UE does not expect that the value of codebookSubset (higher signaling) will be configured as “fully AndPartialAndNonCoherent”. In addition, if the UE reported “nonCoherent” as UE capability, UE does not expect that the value of codebookSubset (higher signaling) will be configured as “fully AndPartialAndNonCoherent” or “partialAndNonCoherent”. If nrofSRS-Ports inside SRS-ResourceSet (higher signaling) indicates two SRS antenna ports, the UE does not expect that the value of codebookSubset (higher signaling) will be configured as “partialAndNonCoherent”.

The UE may have one SRS resource set configured therefor, wherein the value of usage inside SRS-ResourceSet (higher signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (higher signaling) is identical for all SRS resources.

The UE transmits, to the base station, one or multiple SRS resources included in the SRS resource set wherein the value of usage is configured as “codebook” according to higher signaling, and the base station selects one from the SRS resources transmitted by the UE and instructs the UE to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically configured by a configured grant. If at least one SRS resource is configured inside an SRS resource set wherein the value of usage inside SRS-ResourceSet (higher signaling) is “nonCodebook”, non-codebook-based PUSCH transmission may be scheduled for the UE through DCI format 0_1.

With regard to the SRS resource set wherein the value of usage inside SRS-ResourceSet (higher signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (higher signaling) is “aperiodic”, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (higher signaling). With regard to non-codebook-based transmission, the UE does not expect that spatialRelationInfo, which is higher signaling regarding the SRS resource, and associatedCSI-RS inside SRS-ResourceSet, which is higher signaling, will be configured together.

If multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (higher signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (higher signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

### [Regarding CA/DC]

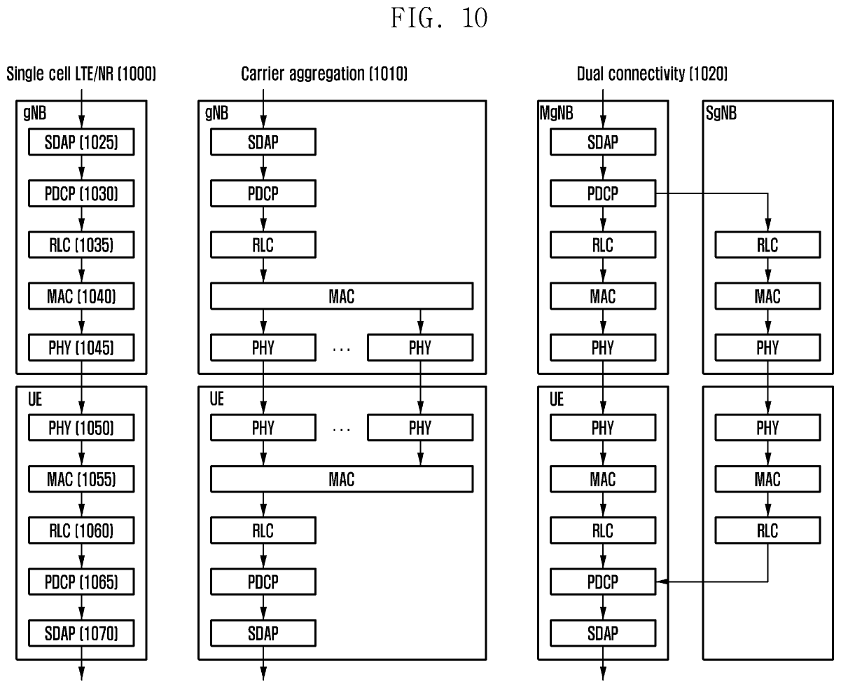

FIG. 10 illustrates radio protocol structures of a base station and a UE in single cell, carrier aggregation, and dual connectivity situations according to an embodiment of the disclosure.

Referring to FIG. 10, the radio protocol of a next-generation mobile communication system includes an NR service data adaptation protocol (SDAP) 1025 or 1070, an NR packet data convergence protocol (PDCP) 1030 or 1065, an NR radio link control (RLC) 1035 or 1060, and an NR medium access controls (MAC) 1040 or 1055, on each of UE and NR base station sides.

The main functions of the NR SDAP 1025 or 1070 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

The main functions of the NR PDCP 1030 or 1065 may include some of the following functions: below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The main functions of the NR RLC 1035 or 1060 may include some of the following functions: below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The NR MAC 1040 or 1055 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 1045 or 1050 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The detailed structure of the radio protocol structure may be variously changed according to the carrier (or cell) operating scheme. For example, in case that the base station transmits data to the UE, based on a single carrier (or cell), the base station and the UE may use a protocol structure having a single structure with regard to each layer, such as 1000. On the other hand, in case that the base station transmits data to the UE, based on carrier aggregation (CA) which uses multiple carriers in a single TRP, the base station and the UE may use a protocol structure which has a single structure up to the RLC, but multiplexes the PHY layer through a MAC layer, such as 1010. As another example, in case that the base station transmits data to the UE, based on dual connectivity which uses multiple carriers in multiple TRPs, the base station and the UE may use a protocol structure which has a single structure up to the RLC but multiplexes the PHY layer through a MAC layer, such as 1020.

### [PUCCH: Regarding Transmission]

In the NR system, the UE may transmit control information (uplink control information (UCI)) to the base station through a physical uplink control channel (PUCCH). The control information may include at least one of hybrid automatic repeat request acknowledgement (HARQ-ACK) indicating success or failure of demodulation/decoding for a transport block (TB) received by the UE through a PDSCH, scheduling request (SR) for requesting resource allocation by the UE from a PUSCH base station for uplink data transmission, and channel state information (CSI), which is information for reporting the channel state of the UE.

The PUCCH resource may be largely divided into a long PUCCH and a short PUCCH according to the length of the allocated symbol. In the NR system, the long PUCCH has a length of 4 symbols or more in a slot, and the short PUCCH has a length of 2 symbols or less in a slot.

In more detail about the long PUCCH, the long PUCCH may be used for the purpose of improving uplink cell coverage, and thus may be transmitted in a DFT-S-OFDM scheme, which is a single carrier transmission rather than an OFDM transmission. The long PUCCH supports transmission formats such as PUCCH format 1, PUCCH format 3, and PUCCH format 4 depending on the number of supportable control information bits and whether UE multiplexing through Pre-DFT OCC support at the front end of the IFFT is supported.

First, the PUCCH format 1 is a discrete Fourier transform spread orthogonal frequency division multiplexing (DFT-S-OFDM)-based long PUCCH format capable of supporting up to 2 bits of control information, and uses as much frequency resources as 1 RB. The control information may be configured by a combination of HARQ-ACK and SR or each of them. In PUCCH format 1, an OFDM symbol including a DMRS that is a demodulation reference signal (or a reference signal) and an OFDM symbol including UCI are repeatedly configured.

For example, when the number of transmission symbols of PUCCH format 1 is 8 symbols, the first start symbol of 8 symbols may be sequentially configured by DMRS symbol, UCI symbol, DMRS symbol, UCI symbol, DMRS symbol, UCI symbol, DMRS symbol, and UCI symbol. The DMRS symbol may be spread using an orthogonal code (or orthogonal sequence or spreading code, wᵢ(m)) on the time axis to a sequence corresponding to the length of 1 RB on the frequency axis within one OFDM symbol, and may be transmitted after performing IFFT thereon.

With respect to the UCI symbol, the UE may generate d(0) by BPSK modulating 1-bit control information and QPSK modulating 2-bit control information, multiply the generated d(0) by a sequence corresponding to the length of 1 RB on the frequency axis to scramble, spread the scrambled sequence using an orthogonal code (or an orthogonal sequence or spreading code, wᵢ(m)) on the time axis, and transmit the same after performing the IFFT thereon.

The UE generates the sequence, based on the group hopping or sequence hopping configuration and the configured ID configured via higher layer signaling from the base station, and generates a sequence corresponding to a length of 1 RB by cyclic shifting the generated sequence with an initial cyclic shift (CS) value configured via a higher signal.

$${w}_{i} ( m ) = {e}^{\frac{j 2 πϕ ( m )}{{N}_{SF}}}$$

The wᵢ(m) is determined as when the length of the spreading code (NSF) is given, and specifically given as shown in Table 18 below. In the above, “i’ refers to the index of the spreading code itself, and “m” refers to the index of the elements of the spreading code. Here, the numbers in [ ] in Table 18 refer to “m”, and for example, if the length of the spreading code is 2 and the index of the configured spreading code is i=0, the spreading code wᵢ(m) is expressed as wᵢ(0)=e^{j2x∈0/N}^{_{SF}}=1, wᵢ(0)=e^{j2x∈0/N}^{_{SF}}=1, and therefore wᵢ(m)=[1 1].

TABLE 18

| | φ | | | | | | |
|---|---|---|---|---|---|---|---|
| N_{SF, m′}^{PUCCH, 1} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

Next, the PUCCH format 3 is a DFT-S-OFDM-based long PUCCH format capable of supporting more than 2 bits of control information, and the number of RBs used can be configured through a higher layer. The control information may consist of a combination of HARQ-ACK, SR, and CSI, or each of them. In the PUCCH format 3, the location of the DMRS symbol is presented according to whether frequency hopping occurs in the slot and whether additional DMRS symbols are configured, as illustrated in Table 19 below.

TABLE 19

| | DMRS location in PUCCH format 3/4 transmission | | | |
|---|---|---|---|---|
| | Additional DMRS | | Additional DMRS | |
| PUCCH | is not configured | | is configured | |
| format 3/4 | Frequency | Frequency | Frequency | Frequency |
| transmission | hopping is | hopping is | hopping is | hopping is |
| length | not configured | configured | not configured | configured |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

For example, when the number of transmission symbols of the PUCCH format 3 is 8 symbols, the first start symbol of the 8 symbols starts with 0, and the DMRS is transmitted in the first symbol and the fifth symbol. Table 21 is applied in the same manner to the DMRS symbol position of the PUCCH format 4.

Next, the PUCCH format 4 is a DFT-S-OFDM-based long PUCCH format capable of supporting more than 2 bits of control information, and uses as much frequency resources as 1 RB. The control information may be configured by a combination of HARQ-ACK, SR, and CSI, or each of them. The difference between the PUCCH format 4 and the PUCCH format 3 is that in case of the PUCCH format 4, the PUCCH format 4 of multiple UEs can be multiplexed within one RB. It is possible to multiplex PUCCH format 4 of a plurality of UEs through application of Pre-DFT orthogonal cover code (OCC) to control information in the front of the IFFT. However, the number of transmittable control information symbols of one UE decreases according to the number of multiplexed UEs. The number of multiplexable UEs, that is, the number of different OCCs that can be used, may be 2 or 4, and the number of OCCs and the OCC index to be applied may be configured through a higher layer.

Next, the short PUCCH will be described. The short PUCCH may be transmitted in both a downlink centric slot and an uplink centric slot. In general, the short PUCCH may be transmitted in the last symbol of the slot or an OFDM symbol at the end (e.g., the last OFDM symbol, the second OFDM symbol from the end, or the last 2 OFDM symbols). Of course, it is also possible to transmit the short PUCCH at any location in the slot. In addition, the short PUCCH may be transmitted using one OFDM symbol or two OFDM symbols. The short PUCCH may be used to shorten a delay time compared to the long PUCCH in a situation where uplink cell coverage is good, and may be transmitted in a CP-OFDM scheme.

The short PUCCH may support transmission formats such as PUCCH format 0 and PUCCH format 2 according to the number of supportable control information bits. First, the PUCCH format 0 is a short PUCCH format capable of supporting up to 2 bits of control information, and uses frequency resources of 1 RB. The control information may be configured by a combination of HARQ-ACK and SR or each of them. The PUCCH format 0 is a structure in which only sequences mapped to 12 subcarriers in the frequency axis in one OFDM symbol are transmitted, instead of transmitting DMRS. The UE may generate a sequence, based on the group hopping or sequence hopping configuration and configured ID configured as a higher signal from the base station, cyclic shift the generated sequence to the final CS value obtained by adding another CS value according to whether it is ACK or NACK to the indicated initial CS value, map it to 12 subcarriers, and transmit the same.

For example, when HARQ-ACK is 1 bit, as shown in the following Table 20, if it is ACK, 6 is added to the initial CS value to generate the final CS, and if it is NACK, 0 is added to the initial CS to generate the final CS. The CS value 0 for NACK and the CS value 6 for ACK are defined in the standard, and the UE may generate PUCCH format 0 according to a value defined in the standard to transmit 1-bit HARQ-ACK.

TABLE 20

| 1-bit HARQ-ACK | NACK | ACK |
|---|---|---|
| Final CS | (Initial CS + 0) | (Initial CS + |
| | mod 12 = initial CS | 6) mod 12 |

For example, when HARQ-ACK is 2 bits, the UE adds 0 to the initial CS value if it is (NACK, NACK), adds 3 to the initial CS value if it is (NACK, ACK), adds 6 to the initial CS value if it is (ACK, ACK), and adds 9 to the initial CS value if it is (ACK, NACK), as shown in Table 21 below. The CS value 0 for (NACK, NACK), the CS value 3 for (NACK, ACK), the CS value 6 for (ACK, ACK), and the CS value 9 for (ACK, NACK) are defined in the standard. The UE may transmit a 2-bit HARQ-ACK by generating PUCCH format 0 according to the value defined in the standard. In case that the final CS value exceeds 12 by the CS value added according to ACK or NACK to the initial CS value, since the sequence length is 12, modulo 12 may be applied to the final CS value.

TABLE 21

| 2-bit | NACK, | NACK, | ACK, | ACK, |
|---|---|---|---|---|
| HARQ-ACK | NACK | ACK | ACK | NACK |
| Final CS | (Initial CS + | (Initial | (Initial | (Initial |
| | 0) mod 12 = | CS + 3) | CS + 6) | CS + 9) |
| | Initial CS | mod 12 | mod 12 | mod 12 |

Next, the PUCCH format 2 is a short PUCCH format that supports more than 2 bits of control information, and the number of RBs used may be configured via higher layer signaling. The control information may be configured by a combination of HARQ-ACK, SR, and CSI, or each of them. In the PUCCH format 2, the position of the subcarrier through which the DMRS is transmitted within one OFDM symbol is fixed to the subcarrier having indexes of #1, #4, #7, and #10, when the index of the first subcarrier is #0. The control information may be mapped to the remaining subcarriers through a modulation process after channel coding except for the subcarrier in which the DMRS is located.

In summary, values that can be configured for each of the above-described PUCCH formats and their ranges may be arranged as illustrated in Table 22 below. In case that the value does not need to be configured in the Table 22, it is indicated as N.A.

TABLE 22

| | | PUCCH | PUCCH | PUCCH | PUCCH | PUCCH |
|---|---|---|---|---|---|---|
| | | Format 0 | Format 1 | Format 2 | Format 3 | Format 4 |
| Starting | Configurability | ◯ | ◯ | ◯ | ◯ | ◯ |
| symbol | Value range | 0-13 | 0-10 | 0-13 | 0-10 | 0-10 |
| Number of | Configurability | ◯ | ◯ | ◯ | ◯ | ◯ |
| symbols in | Value range | 1, 2 | 4-14 | 1, 2 | 4-14 | 4-14 |
| a slot | | | | | | |
| Index for | Configurability | ◯ | ◯ | ◯ | ◯ | ◯ |
| identifying | Value range | 0-274 | 0-274 | 0-274 | 0-274 | 0-274 |
| starting PRBs | | | | | | |
| Number | Configurability | N.A. | N.A. | ◯ | ◯ | N.A. |
| of PRBs | Value range | N.A. | N.A. | 1-16 | 1-6, 8-10, | N.A. |
| | | (Default | (Default | | 12, 15, 16 | (Default |
| | | is 1) | is 1) | | | is 1) |
| Enabling | Configurability | ◯ | ◯ | ◯ | ◯ | ◯ |
| frequency | Value range | On/Off | On/Off | On/Off | On/Off | On/Off |
| hopping | | (only for | | (only for | | |
| (FH) | | 2 symbol) | | 2 symbol) | | |
| Frequency | Configurability | ◯ | ◯ | ◯ | ◯ | ◯ |
| resource of | Value range | 0-274 | 0-274 | 0-274 | 0-274 | 0-274 |
| 2nd hop if FH | | | | | | |
| is enabled | | | | | | |
| Index of | Configurability | ◯ | ◯ | N.A. | N.A. | N.A. |
| initial | Value range | 0-11 | 0-11 | N.A. | 0-11 | 0-11 |
| cyclic shift | | | | | | |
| Index of | Configurability | N.A. | ◯ | N.A. | N.A. | N.A. |
| time-domain | Value range | N.A. | 0-6 | N.A. | N.A. | N.A. |
| OCC | | | | | | |
| Length of | Configurability | N.A. | N.A. | N.A. | N.A. | ◯ |
| Pre-DFT | Value range | N.A. | N.A. | N.A. | N.A. | 2, 4 |
| OCC | | | | | | |
| Index of | Configurability | N.A. | N.A. | N.A. | N.A. | ◯ |
| Pre-DFT | Value range | N.A. | N.A. | N.A. | N.A. | 0, 1, 2, 3 |
| OCC | | | | | | |

Meanwhile, in order to improve uplink coverage, multi-slot repetition may be supported for PUCCH formats 1, 3, and 4, PUCCH repetition may be configured for each PUCCH format. The UE may repeatedly transmit the PUCCH including UCI as many as the number of slots configured through nrofSlots, which is higher layer signaling. For the repeated PUCCH transmission, the PUCCH transmission in each slot may be performed using the same number of consecutive symbols, and the number of corresponding consecutive symbols may be configured through a nrofSymbols in the PUCCH-format 1, the PUCCH-format 3, or the PUCCH-format 4, which is higher layer signaling. For the repeated PUCCH transmission, the PUCCH transmission in each slot may be performed using the same start symbol, and the corresponding start symbol may be configured through a startingSymbolIndex in the PUCCH-format 1, the PUCCH-format 3, or the PUCCH-format 4, which is higher layer signaling. For the repeated PUCCH transmission, a single PUCCH-spatialRelationInfo may be configured for a single PUCCH resource.

For the repeated PUCCH transmission, if the UE has been configured to perform frequency hopping in PUCCH transmission in different slots, the UE performs frequency hopping in units of slots. In addition, if the UE has been configured to perform frequency hopping in the PUCCH transmission in different slots, the UE starts the PUCCH transmission from the first PRB index configured through startingPRB, which is higher layer signaling, in the even-numbered slot, and in the odd-numbered slot, the UE starts the PUCCH transmission from the second PRB index configured through secondHopPRB, which is higher layer signaling. Additionally, if the UE is configured to perform frequency hopping in PUCCH transmission in different slots, the index of the slot in which the UE is instructed to transmit the first PUCCH is 0, and during the configured total number of repeated PUCCH transmissions, the value of the number of repeated PUCCH transmissions is increased in each slot regardless of the PUCCH transmission performed. If the UE is configured to perform frequency hopping in PUCCH transmission in different slots, the UE does not expect that frequency hopping in the slot is configured when transmitting PUCCH. If the UE is not configured to perform frequency hopping in PUCCH transmission in different slots but is configured for frequency hopping in a slot, the first and second PRB indexes are applied equally in the slot.

If the number of uplink symbols available for PUCCH transmission is less than nrofSymbols set in higher layer signaling, the UE may not transmit PUCCH. If the UE fails to transmit a PUCCH in any slot during a PUCCH repeated transmission for any reason, the UE may increase the number of PUCCH repeated transmissions.

### [PUCCH: PUCCH Transmission Resource]

Next, the PUCCH resource configuration of the base station or the UE is described. The base station may configure PUCCH resources for each BWP through a higher layer for a specific UE. The PUCCH resource configurations may be as shown in Table 23 below.

TABLE 23

| | |
|---|---|
| PUCCH-Config ::= | SEQUENCE { |

| | |
|---|---|
| resourceSetToAddModList | SEQUENCE (SIZE (1..maxNrofPUCCH- |
| ResourceSets)) OF PUCCH-ResourceSet | OPTIONAL, -- Need N |
| resourceSetToReleaseList | SEQUENCE (SIZE (1..maxNrofPUCCH- |
| ResourceSets)) OF PUCCH-ResourceSetId | OPTIONAL, -- Need N |
| resourceToAddModList | SEQUENCE (SIZE (1..maxNrofPUCCH- |
| Resources)) OF PUCCH-Resource | OPTIONAL, -- Need N |
| resourceToReleaseList | SEQUENCE (SIZE (1..maxNrofPUCCH- |
| Resources)) OF PUCCH-ResourceId | OPTIONAL, -- Need N |
| format1 | SetupRelease { PUCCH-FormatConfig } |

OPTIONAL, -- Need M

| | |
|---|---|
| format2 | SetupRelease { PUCCH-FormatConfig } |

OPTIONAL, -- Need M

| | |
|---|---|
| format3 | SetupRelease { PUCCH-FormatConfig } |

OPTIONAL, -- Need M

| | |
|---|---|
| format4 | SetupRelease { PUCCH-FormatConfig } |

OPTIONAL, -- Need M

| | |
|---|---|
| schedulingRequestResourceToAddModList | SEQUENCE (SIZE |

(1..maxNrofSR-Resources)) OF SchedulingRequestResourceConfig
OPTIONAL, -- Need N

| | |
|---|---|
| schedulingRequestResourceToReleaseList | SEQUENCE (SIZE |

(1..maxNrofSR-Resources)) OF SchedulingRequestResourceId
OPTIONAL, -- Need N

| | |
|---|---|
| multi-CSI-PUCCH-ResourceList | SEQUENCE (SIZE (1..2)) OF PUCCH- |

| | |
|---|---|
| ResourceId | OPTIONAL, -- Need M |

| | |
|---|---|
| dl-DataToUL-ACK | SEQUENCE (SIZE (1..8)) OF INTEGER |

| | |
|---|---|
| (0..15) | OPTIONAL, -- Need M |

| | |
|---|---|
| spatialRelationInfoToAddModList | SEQUENCE (SIZE |

(1..maxNrofSpatialRelationInfos)) OF PUCCH-SpatialRelationInfo
OPTIONAL, -- Need N

| | |
|---|---|
| spatialRelationInfoToReleaseList | SEQUENCE (SIZE |

(1..maxNrofSpatialRelationInfos)) OF PUCCH-SpatialRelationInfoId
OPTIONAL, -- Need N

| | |
|---|---|
| pucch-PowerControl | PUCCH-PowerControl |

```
OPTIONAL, -- Need M
  ...,
  [[
```

| | |
|---|---|
| resourceToAddModListExt-r16 | SEQUENCE (SIZE |
| (1..maxNrofPUCCH-Resources)) OF PUCCH-ResourceExt-r16 | OPTIONAL, -- |

Need N

| | |
|---|---|
| dl-DataToUL-ACK-r16 | SetupRelease { DL-DataToUL-ACK-r16 } |

OPTIONAL, -- Need M

| | |
|---|---|
| ul-AccessConfigListDCI-1-1-r16 | SetupRelease { UL- |
| AccessConfigListDCI-1-1-r16 } | OPTIONAL, -- Need M |
| subslotLengthForPUCCH-r16 | CHOICE { |
| normalCP-r16 | ENUMERATED {n2,n7}, |
| extendedCP-r16 | ENUMERATED {n2,n6} |
| } | OPTIONAL, |

-- Need R

| | |
|---|---|
| dl-DataToUL-ACK-DCI-1-2-r16 | SetupRelease { DL-DataToUL-ACK- |

| | |
|---|---|
| DCI-1-2-r16} | OPTIONAL, -- Need M |

| | |
|---|---|
| numberOfBitsForPUCCH-ResourceIndicatorDCI-1-2-r16 | INTEGER (0..3) |

OPTIONAL, -- Need R

| | |
|---|---|
| dmrs-UplinkTransformPrecodingPUCCH-r16 | ENUMERATED {enabled} |

OPTIONAL, -- Cond PI2-BPSK

| | |
|---|---|
| spatialRelationInfoToAddModListSizeExt-v1610 | SEQUENCE (SIZE |

(1..maxNrofSpatialRelationInfosDiff-r16)) OF PUCCH-SpatialRelationInfo
OPTIONAL, -- Need N

| | |
|---|---|
| spatialRelationInfoToReleaseListSizeExt-v1610 | SEQUENCE (SIZE |

(1..maxNrofSpatialRelationInfosDiff-r16)) OF PUCCH-SpatialRelationInfoId
OPTIONAL, -- Need N

| | |
|---|---|
| spatialRelationInfoToAddModListExt-v1610 | SEQUENCE (SIZE |

(1..maxNrofSpatialRelationInfos-r16)) OF PUCCH-SpatialRelationInfoExt-r16
OPTIONAL, -- Need N

| | |
|---|---|
| spatialRelationInfoToReleaseListExt-v1610 | SEQUENCE (SIZE |

(1..maxNrofSpatialRelationInfos-r16)) OF

PUCCH-SpatialRelationInfoId-

r16 OPTIONAL, -- Need N

| | |
|---|---|
| resourceGroupToAddModList-r16 | SEQUENCE (SIZE |

(1..maxNrofPUCCH-ResourceGroups-r16)) OF PUCCH-ResourceGroup-r16
OPTIONAL, -- Need N

| | |
|---|---|
| resourceGroupToReleaseList-r16 | SEQUENCE (SIZE |

(1..maxNrofPUCCH-ResourceGroups-r16)) OF PUCCH-ResourceGroupId-r16
OPTIONAL, -- Need N

| | |
|---|---|
| sps-PUCCH-AN-List-r16 | SetupRelease { SPS-PUCCH-AN-List- |

| | |
|---|---|
| r16 } | OPTIONAL, -- Need M |

| | |
|---|---|
| schedulingRequestResourceToAddModListExt-v1610 | SEQUENCE (SIZE |

(1..maxNrofSR-Resources)) OF SchedulingRequestResourceConfigExt-v1610
OPTIONAL -- Need N
]]
}

According to the Table 23, one or a plurality of PUCCH resource sets in the PUCCH resource configuration for a specific BWP may be configured, and a maximum payload value for UCI transmission may be configured in some of the PUCCH resource sets. Each PUCCH resource set may belong to one or more PUCCH resources, and each of the PUCCH resources may belong to one of the above-described PUCCH formats.

For the PUCCH resource set, the maximum payload value of the first PUCCH resource set may be fixed to 2 bits. Accordingly, the corresponding value may not be separately configured through a higher layer. When the remaining PUCCH resource set is configured, the index of the corresponding PUCCH resource set may be configured in ascending order according to the maximum payload value, and the maximum payload value may not be configured in the last PUCCH resource set. The higher layer configuration for the PUCCH resource set may be as illustrated in Table 24 below.

TABLE 24

| | |
|---|---|
| PUCCH-ResourceSet ::= | SEQUENCE { |
| pucch-ResourceSetId | PUCCH-ResourceSetId, |
| resourceList | SEQUENCE (SIZE (1..maxNrofPUCCH- |

ResourcesPerSet)) OF PUCCH-ResourceId,

| | |
|---|---|
| maxPayloadSize | INTEGER (4..256) |

OPTIONAL -- Need R
}

The resourceList parameter of Table 24 may include IDs of PUCCH resources belonging to the PUCCH resource set.

If during initial access or when the PUCCH resource set is not configured, a PUCCH resource set, as shown in Table 25 below, consisting of a plurality of cell-specific PUCCH resources in the initial BWP, may be used. The PUCCH resource to be used for initial access in this PUCCH resource set may be indicated through SIB1.

TABLE 25

| | PUCCH | First | Number of | PRB offset | Set of initial |
|---|---|---|---|---|---|
| Index | format | symbol | symbols | N_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | *N_{BWP}^{size}/4+ | {0, 3, 6, 9} |

The maximum payload of each PUCCH resource included in the PUCCH resource set may be 2 bits in case of PUCCH format 0 or 1, and may be determined by symbol length, number of PRBs, and maximum code rate in case of the remaining formats. The symbol length and number of PRBs may be configured for each PUCCH resource, and the maximum code rate may be configured for each PUCCH format.

Next, PUCCH resource selection for UCI transmission is described. In a case of SR transmission, a PUCCH resource for an SR corresponding to schedulingRequestID may be configured through a higher layer as shown in Table 26. The PUCCH resource may be a resource belonging to PUCCH format 0 or PUCCH format 1.

TABLE 26

| SchedulingRequestResourceConfig ::= | SEQUENCE { | |
|---|---|---|
| schedulingRequestResourceId | SchedulingRequestResourceId, | |
| schedulingRequestID | SchedulingRequestId, | |
| periodicityAndOffset | CHOICE { | |
| sym2 | NULL, | |
| sym6or7 | NULL, | |
| sl1 | NULL, | -- Recurs in every slot |

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15). |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

| | |
|---|---|
| } | OPTIONAL, |

-- Need M

| | |
|---|---|
| resource | PUCCH-ResourceId |

OPTIONAL -- Need M
}

For the configured PUCCH resource, a transmission period and an offset are configured through the periodicityAndOffset parameter of Table 28. When there is uplink data to be transmitted by the UE at a time point corresponding to the configured period and offset, the corresponding PUCCH resource is transmitted, otherwise the corresponding PUCCH resource may not be transmitted.

In a case of CSI transmission, a PUCCH resource for transmitting a periodic or semi-persistent CSI report through a PUCCH may be configured in a pucch-CSI-ResourceList parameter as illustrated in Table 27. The pucch-CSI-ResourceList parameter may include a list of PUCCH resources for each BWP for the cell or CC to which the corresponding CSI report is to be transmitted. The PUCCH resource may be a resource belonging to PUCCH format 2, PUCCH format 3, or PUCCH format 4. For the PUCCH resource, a transmission period and an offset may be configured through reportSlotConfig of Table 27.

TABLE 27

| CSI-ReportConfig ::= | SEQUENCE { | |
|---|---|---|
| reportConfigId | CSI-ReportConfigId, | |
| carrier | ServCellIndex | OPTIONAL, -- Need S |

...

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |

OF PUCCH-CSI-Resource
},

| | |
|---|---|
| semiPersistentOnPUSCH | SEQUENCE { |
| reportSlotConfig | ENUMERATED {sl5, sl10, sl20, sl40, |

sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL- |

```
Allocations)) OF INTEGER(0..32)
    }
  },
  ...
}
```

In the case of HARQ-ACK transmission, a resource set of PUCCH resources to be transmitted is first selected according to the payload of the UCI including the corresponding HARQ-ACK. That is, a PUCCH resource set having a minimum payload not smaller than the UCI payload is selected. Next, the PUCCH resource in the PUCCH resource set may be selected through the PUCCH resource indicator (PRI) in the DCI scheduling the TB corresponding to the corresponding HARQ-ACK, and the PRI may be the PUCCH resource indicator specified in Table 6 or Table 7. The relationship between the PRI and the PUCCH resource selected from the PUCCH resource set may be as illustrated in Table 28.

TABLE 28

| PUCCH resource | |
|---|---|
| indicator | PUCCH resource |
| ‘000’ | 1^{st} PUCCH resource provided by pucch-ResourceId |
| | obtained from the 1^{st} value of resourceList |
| ‘001’ | 2^{nd} PUCCH resource provided by pucch-ResourceId |
| | obtained from the 2^{nd} value of resourceList |
| ‘010’ | 3^{rd} PUCCH resource provided by pucch-ResourceId |
| | obtained from the 3^{rd} value of resourceList |
| ‘011’ | 4^{th} PUCCH resource provided by pucch-ResourceId |
| | obtained from the 4^{th} value of resourceList |
| ‘100’ | 5^{th} PUCCH resource provided by pucch-ResourceId |
| | obtained from the 5^{th} value of resourceList |
| ‘101’ | 6^{th} PUCCH resource provided by pucch-ResourceId |
| | obtained from the 6^{th} value of resourceList |
| ‘110’ | 7^{th} PUCCH resource provided by pucch-ResourceId |
| | obtained from the 7^{th} value of resourceList |
| ‘111’ | 8^{th} PUCCH resource provided by pucch-ResourceId |
| | obtained from the 8^{th} value of resourceList |

If the number of PUCCH resources in the selected PUCCH resource set is greater than 8, the PUCCH resource may be selected by the following equation.

$${r}_{PUCCH} = \{ \begin{matrix}⌊ \frac{{n}_{CCE , p} \cdot ⌈ {R}_{PUCCH} / 8 ⌉}{{N}_{CCE , p}} ⌋ + {Δ}_{PRI} \cdot ⌈ \frac{{R}_{PUCCH}}{8} ⌉ if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot ⌊ \frac{{R}_{PUCCH}}{8} ⌋ + \\ {R}_{PUCCH} mod 8 if {Δ}_{PRI} \geq {R}_{PUCCH} mod 8\end{matrix}\end{matrix} \}$$

In Equation, r_{PUCCH} is the index of the selected PUCCH resource in the PUCCH resource set, R_{PUCCH} is the number of PUCCH resources belonging to the PUCCH resource set, Δ_{PRI} is the PRI value, N_{CCE,p} is the total number of CCEs of the CORESET p to which the receiving DCI belongs, and n_{CCE,p} is the first CCE index for the receiving DCI.

The time point at which the corresponding PUCCH resource is transmitted is after the K₁ slot from the TB transmission corresponding to the corresponding HARQ-ACK. Candidates of K₁ value may be configured via a higher layer and, more specifically, be configured in the dl-DataToUL-ACK parameter in the PUCCH-Config specified in Table 23. The K₁ value of one of these candidates may be selected by the PDSCH-to-HARQ feedback timing indicator in the DCI scheduling the TB, and this value may be a value specified in Table 5 or Table 6. Meanwhile, the unit of the K₁ value may be a slot unit or a sub slot unit. Here, a sub slot is a unit of a length smaller than that of a slot, and one or a plurality of symbols may constitute one sub slot.

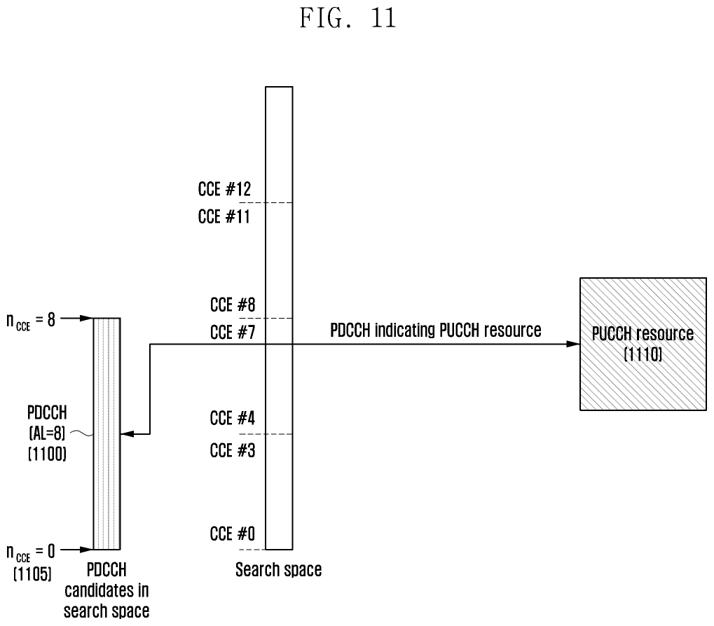

FIG. 11 illustrates a method of determining the PUCCH resource. The lowest CCE index of a PDCCH 1100, having an aggregation level of 8, is n_{CCE}=0 (indicated by as reference numeral 1105). If the UE receives DCI from PDCCH X of aggregation level 8, the PUCCH resource may be determined according to the lowest CCE index of 0. Here, the PUCCH resource 1110 is indicated. As such, different PUCCH resources may be indicated due to different lowest CCE indices of the PDCCHs from which the UE has received the DCI.

Here, N_{CCE,p} is the number of CCEs contained in the CORESET p from which the DCI has been received, n_{CCE,p} is the lowest CCE index (or starting CCE index) of the PDCCH from which the DCI has been received, and Δ_{PRI} is the value of the PUCCH resource indicator field of the DCI, and has one of values of 0, 1, 2, 3, 4, 5, 6, or 7. R_{PUCCH} is the number of PUCCH resources configured within the PUCCH resource set and is greater than or equal to 8 and less than or equal to 32. According to Equation 3, r_{PUCCH} may have one of the values of 0, 1, 2, . . . R_{PUCCH}−1.

In order to indicate PUCCH resources according to Equation 3 above, the UE should determine the lowest CCE index (or starting CCE index) of the PDCCH from which the DCI has been received.

Next, the case where two or more PUCCH resources are located within one slot is described. The UE may transmit UCI through one or two PUCCH resources within one slot or subslot, and when UCI is transmitted through two PUCCH resources within one slot/subslot, i) each PUCCH resource does not overlap in units of symbols, and ii) at least one PUCCH resource may be a short PUCCH. On the other hand, the UE may not expect to transmit multiple PUCCH resources for HARQ-ACK transmission within one slot.

Hereinafter, embodiments of the disclosure will be described in detail in conjunction with the accompanying drawings. Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

In the following description, a base station (is an entity that allocates resources to terminals, and may be at least one of a gNode B, a gNB, an eNode B, a Node B, a wireless access unit, a base station controller, or a node on a network. A terminal may include a user equipment (UE), a mobile station (MS), a cellular phone, a smartphone, a computer, or a multimedia system capable of performing a communication function. In the following description of embodiments of the disclosure, a 5G system will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may be applied to other communication systems through some modifications without significantly departing from the scope of the disclosure. The contents of the disclosure may be applied to frequency division duplex (FDD), time division duplex (TDD), and cross division duplex (XDD) systems.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
Physical uplink control channel (PUCCH)
Uplink control information (UCI)

### [SBFD: SBFD Overview]

Meanwhile, 3GPP is discussing subband non-overlapping full duplex (SBFD) using a new duplex scheme based on NR. SBFD is a technology in which, with uplink resources increased by using some of downlink resources as uplink resources in TDD spectrum of frequencies equal to or below 6 GHZ, or equal to or above 6 GHz, a base station may receive uplink transmissions from a UE and extend the uplink coverage of the UE, and receive feedback on downlink transmissions in the extended uplink resources from the UE to reduce feedback delays. In this disclosure, a UE capable of receiving information about whether it supports SBFD from a base station and performing uplink transmission in some of the downlink resources may be referred to as an SBFD UE (SBFD-capable UE) for convenience. The following schemes may be considered to define the above SBFD scheme in the specification and to determine, by the SBFD UE, that the SBFD is supported in a particular cell (or frequency, frequency band).

In a first scheme, in addition to the existing frame structure types of unpaired spectrum (or TDD) or paired spectrum (or FDD), another frame structure type (e.g., frame structure type 2) may be introduced to define the SBFD. Frame structure type 2 may be defined as being supported in a specific frequency or frequency band, or the base station may indicate to the UE via system information whether the SBFD is supported or not. The SBFD UE may determine whether SBFD is supported in the specific cell (or frequency, frequency band) by receiving the system information including whether the SBFD is supported or not.

In a second scheme, it may be indicated whether the SBFD is additionally supported in a specific frequency or frequency band of the existing unpaired spectrum (or TDD) without defining a new frame structure type. In the second scheme, whether the SBFD is additionally supported in a specific frequency or frequency band of the existing unpaired spectrum may be defined, or the base station may indicate to the UE via system information whether the SBFD is supported. The SBFD UE may determine whether the SBFD is supported in the specific cell (or frequency, frequency band) by receiving the system information including whether the SBFD is supported or not.

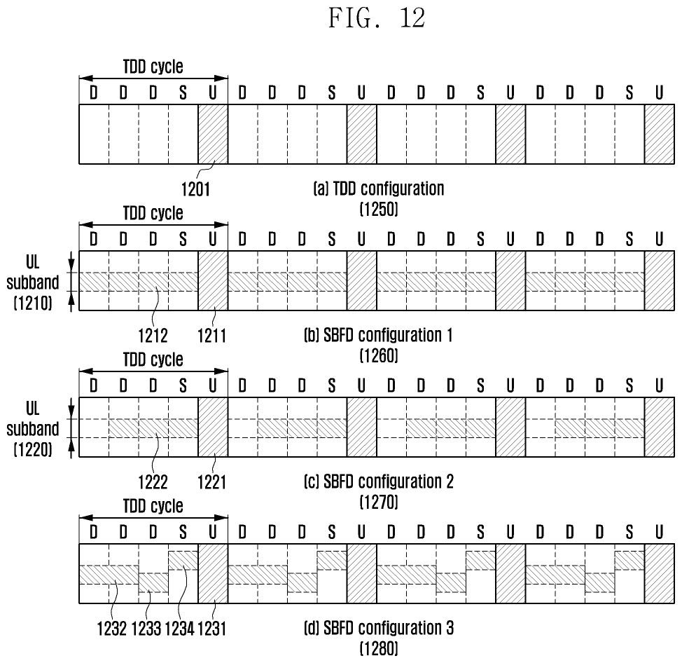

In the first and second schemes above, the information about whether SBFD is supported may be information indicating indirectly whether the SBFD is supported or not (e.g., the SBFD resource configuration information in FIG. 12 below) by configuring some of the downlink resources as an uplink resource in addition to the configuration for the TDD UL-DL resource configuration information indicating the downlink slot (or symbol) resources and the uplink slot (or symbol) resources of the TDD, or may be information indicating directly whether the SBFD is supported or not.

FIG. 12 illustrates an example of SBFD resource configuration information of the disclosure.

As described above, the SBFD resource configuration information may be, in addition to a configuration 1250 for TDD UL-DL resource configuration information indicating downlink slot resources and uplink slot resources of a TDD, information of configuring some of the downlink resources as uplink resources (indicated by reference numerals 1260, 1270, and 1280). Referring to FIG. 12, in the configuration 1250, a slot 1201 in the TDD cycle is configured as a UL slot, and according to SBFD configurations 1, 2, and 3 1260, 1270, and 1280, UL subbands 1210, 1220, 1232, 1233, and 1234, in addition to UL slots 1211, 1221, and 1231, may be configured in DL slots, etc. In this case, the UL subbands may be configured to be the same for each slot or configured differently for each slot. The UE may transmit an uplink shared channel or a control channel by using the configured uplink resource. The information may be transmitted from the base station to the UE by a combination of at least one of higher layer signaling or L1 signaling.

In the disclosure, the SBFD UE may obtain cell synchronization by receiving an SS/PBCH block at an initial cell access to access a cell (or base station). The process of obtaining the cell synchronization may be the same for the SBFD UE and the existing TDD UE. Thereafter, the SBFD UE may determine whether the cell supports SBFD through an MIB acquisition or SIB acquisition or a random access process.

The system information for transmitting the information about whether SBFD is supported may be system information transmitted separately and differently from the system information for a UE (e.g., an existing TDD UE) supporting a different version of the specification within a cell, and the SBFD UE may determine whether the SBFD is supported by obtaining all or part of the system information transmitted separately from the system information for the existing TDD UE. In case that the SBFD UE obtains only system information for the existing TDD UE, or obtains system information for which SBFD is not supported, it may be determined that the cell (or base station) supports only TDD.

In case that the information on whether the SBFD is supported is included in the system information for a UE (e.g., an existing TDD UE) supporting a different version of the specification, the information on whether the SBFD is supported may be inserted at the end so as not to affect the acquisition of system information of the existing TDD UE. In case that the SBFD UE fails to obtain the last inserted information on whether the SBFD is supported, or that the SBFD UE obtains information indicating that the SBFD is not supported, the SBFD UE may determine that the cell (or base station) supports only TDD.

In case that the information on whether the SBFD is supported is included in the system information for a UE supporting a different version of the specification (e.g., an existing TDD UE), the information on whether the SBFD is supported may be transmitted to a separate PDSCH to avoid interfering with the acquisition of system information of the existing TDD UE. In other words, a UE that does not support SBFD may receive a first SIB (or SIB1) including existing TDD-related system information in a first PDSCH. An SBFD-supporting UE may receive a first SIB (or SIB) including existing TDD-related system information in the first PDSCH, and may receive a second SIB including SBFD-related system information in a second PDSCH. Here, the first PDSCH and the second PDSCH may be scheduled via the first PDCCH and the second PDCCH, and the CRCs of the first PDCCH and the second PDCCH may be scrambled by the same RNTI (e.g., SI-RNTI). Control resource information (e.g., search space and/or CORESET information) for monitoring the second PDCCH may be obtained from the system information of the first PDSCH, and if not obtained (i.e., if the system information of the first PDSCH does not include information about the search space), the SBFD-supporting UE may receive the second PDCCH in the same search space as the search space of the first PDCCH.

As described above, when the SBFD UE determines that the cell (or base station) supports TDD only, the SBFD UE may perform a random access procedure and transmit and receive data and control signals in the same manner as the existing TDD UE.

The base station may configure separate random access resources for each of the existing TDD UE or SBFD UE (e.g., an SBFD UE supporting duplex communication and an SBFD UE supporting half-duplex communication), and may transmit configuration information for the random access resources (control information or configuration information indicating the time-frequency resources that may be used for PRACH) to the SBFD UE via system information. The system information for the transmission of information about the random access resource may be separately transmitted system information that is different from system information for a UE (e.g., an existing TDD UE) supporting a different version of the specification within the cell.

By configuring a separate random access resource with respect to the TDD UE supporting a different version of the specification and the SBFD UE, the base station may be possible to distinguish whether random access is performed by the TDD UE supporting a different version of the specification or by the SBFD UEs. For example, the separate random access resource configured for the SBFD UE may be a resource determined as a downlink time resource by the existing TDD UE, and the SBFD UE may perform random access via an uplink resource (or a separate random access resource) configured in a partial frequency of the downlink time resource, so that the base station may determine that a UE attempting random access in the uplink resource is an SBFD UE.

Alternatively, the base station may configure a random access resource common to all UEs in the cell, instead of configuring a separate random access resource for the SBFD UE. In this case, the configuration information for the random access resource may be transmitted to all UEs in the cell via system information, and the SBFD UE that has received the system information may perform random access using the random access resource. Thereafter, the SBFD UE may complete the random access process and proceed to an RRC connection mode for transmitting and receiving data to and from the cell. After the RRC connection mode, the SBFD UE may receive, from the base station, a higher layer signaling or physical signal by which some frequency resources of the downlink time resources are determined to be configured as uplink resources, and may perform an SBFD operation, for example, transmit an uplink signal from the configured uplink resource.

When it is determined that the cell supports SBFD, the SBFD UE may inform the base station that the UE attempting access is the SBFD UE by transmitting UE capability information to the base station, the UE capability information including at least one piece of information such as whether the UE supports SBFD, whether the UE supports full-duplex communication or half-duplex communication, and the number of transmission or reception antennas that the UE has (or supports). Alternatively, if half-duplex communication support is mandatory for the SBFD UE, information as to whether the half-duplex communication is supported may be omitted from the UE capability information. The SBFD UE may report the UE capability information to the base station through a random access process, may report to the base station after completing the random access process, or may report to the base station after proceeding to the RRC connection mode for transmitting and receiving data to and from the cell.

The SBFD UE may support half-duplex communication in which only uplink transmission or downlink reception is performed at one time, like an existing TDD UE, or may support full-duplex communication in which both uplink transmission and downlink reception are simultaneously performed. Therefore, whether the half-duplex communication or full-duplex communication is supported may be reported by the SBFD UE to the base station through a UE capability report, and after the report, the base station may configure the SBFD UE to transmit or receive signals using half-duplex communication or full-duplex communication. When the SBFD UE reports the UE capability for half-duplex communication to the base station, a switching gap may be required to change the RF between transmission and reception when operating in FDD or TDD, since a duplexer generally does not exist.

### [PUCCH: PUCCH Transmission Resource Upon Initial Access]

Unlike the above PUCCH transmission resource determination method, a method of determining the PUCCH transmission resource of the UE upon initial access is described. If the UE is initially accessing a base station, or if the UE does not have a PUCCH resource set configured, the PUCCH resource set as shown in Table 25, which consists of a plurality of cell-specific PUCCH resources in the initial BWP, may be used. PUCCH resources to be used for the initial access within this PUCCH resource set may be indicated via SIB1.

The UE may determine a transmission location in the frequency domain, by using the PUCCH resource set information configured by the SIB1, and the received PDCCH indication information and frequency domain configuration information. The determination of the transmission location in the frequency domain may be calculated using Equation 4 and Equation 5.

$${r}_{P U C C H} = ⋆ \frac{2 E {n}_{CCE , 0}}{{N}_{C C E}} + + 2 E {Δ}_{PRI} \qquad Equation 3$$

r_{PUCCH} is the index of the PUCCH resource calculated from the above equation, Δ_{PRI} is the PRI value, N_{CCE} is the total number of CCEs of the CORESET to which the received DCI belongs, and n_{CCE,0} is the index of the first CCE for the received DCI.

$$If * {r}_{PUCCH} / 8 += 0 \qquad Equation 5$$

$$First hopping : {RB}_{BWP}^{offset} + * {r}_{PUCCH} / {N}_{CS} +$$

$$Second hopping : {N}_{BWP}^{size} - 1 - {RB}_{BWP}^{offset} - * {r}_{PUCCH} / {N}_{CS} +$$

$$If * {r}_{PUCCH} / 8 += 1$$

$$First hopping : {N}_{BWP}^{size} - 1 - {RB}_{BWP}^{offset} - * ( {r}_{PUCCH} - 8 ) / {N}_{CS} +$$

$$Second hopping : {RB}_{BWP}^{offset} + * ( {r}_{PUCCH} - 8 ) / {N}_{CS} +$$

RB_{BVWP}^{offset} is the PRB offset configured from Table 27, N_{CS} is the CS index configured from Table 27, and N_{BWP}^{size} represents the size of the initial UL BWP. As shown in Equation 5, upon initial access, the UE may transmit PUCCH in both ends of the BWP for continuous PUSCH resource configuration. Additionally, upon initial access, the UE may transmit a PUCCH through frequency hopping to obtain frequency diversity.

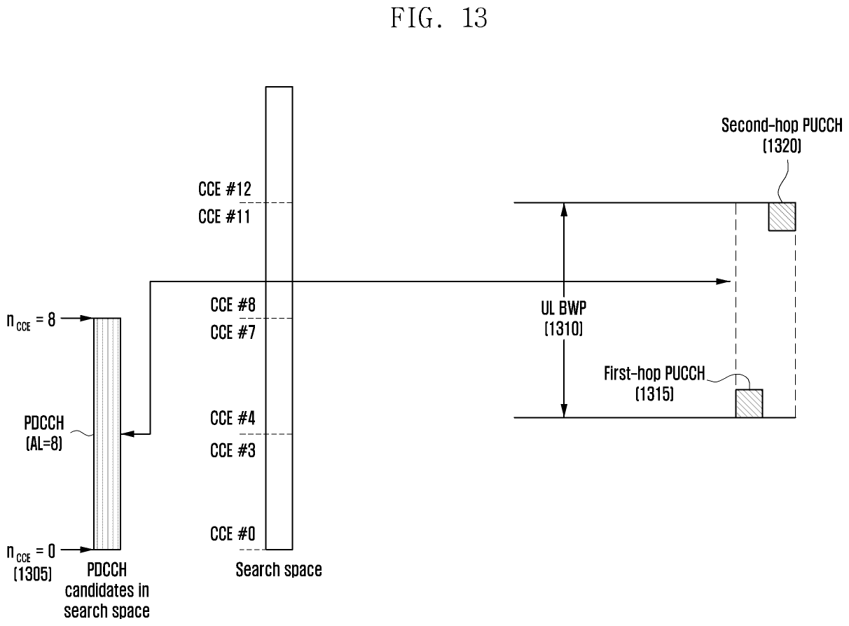

FIG. 13 illustrates PUCCH transmission resource location determination in the frequency domain of the UE during initial access. As described above, the UE may determine the location of the PUCCH in the frequency domain, based on the size of the CCE of the received PDCCH (i.e., DCI), a start point 1305 of the CCE, and PRI, which is DCI indication information. At this time, the reference point for PUCCH resource determination may be an initial UL BWP 1310 configured from SIB1. The UE may determine the location of the PUCCH resource through Equation 4 to Equation 5 above, and frequency hopping may be applied to the calculated PUCCH resource. As an example, PUCCH resources may include a first hopping symbol 1315 and a second hopping symbol 1320. FIG. 13 is an example of one PUCCH transmission, and may differ depending on base station configuration information, PDCCH structure, and DCI indication information.

The PUCCH transmission location in the frequency domain of the initially accessed UE is determined based on the initial UL BWP configured by the base station. Meanwhile, unlike in the existing system (e.g., TDD system) environment, PUCCH transmission in the SBFD environment in which the UL subband is applied to the DL region may occur in the UL subband, and may occur in the UL only region of the TDD system. In this context, in the SBFD environment, if the UE follows the method defined in the TDD system to determine the PUCCH transmission location in the frequency domain (i.e., if the PUCCH transmission location is determined based on the UL BWP), there may be ambiguity in determining the PUCCH transmission resource location in the DL region.

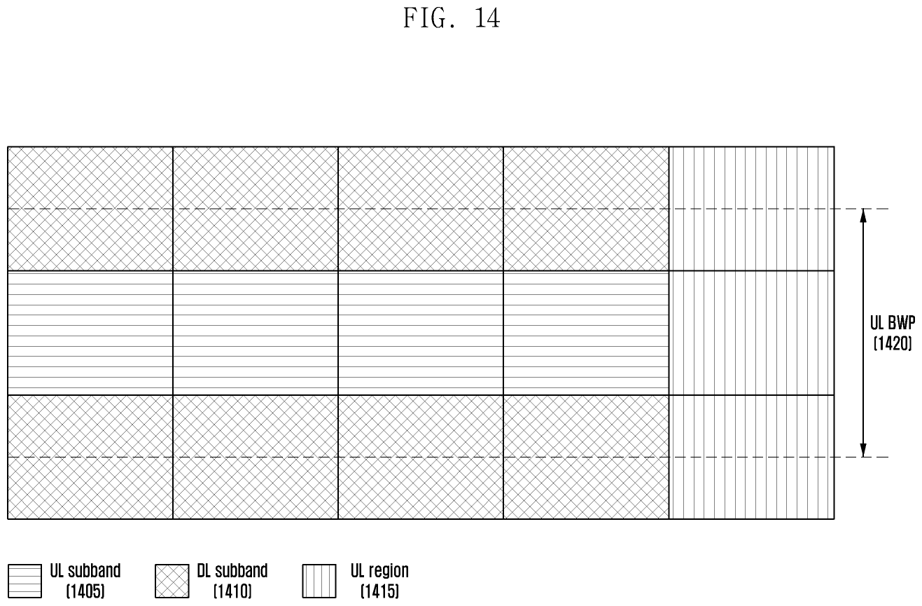

FIG. 14 illustrates an example of SBFD configuration according to an embodiment. The following embodiments describe an SBFD environment. In this case, a UL subband 1405 may be referred to as a subband region in which DL subbands 1410 are located in non-overlapping frequency bands in the same time zone. In addition, a UL region 1415 may be a region in which there is only UL transmission without transmissions in different directions (e.g., downlink transmissions) in the same time zone, and may also be referred to as a UL only region. In addition, a UL BWP 1420 may be an initial UL BWP configured from SIB1 during the initial access stage. In the following embodiments, the description of these terms may be omitted.

The disclosure describes a method in which a UE determines the location of a PUCCH transmission resource in the frequency domain (hereinafter interchangeably referred to as PUCCH transmission location) in an SBFD environment. In an embodiment, there may be a UL BWP-based determination method, a UL subband-based determination method, or a combination of the above methods of the UE, or a configuration-based transmission location method of the base station. Detailed methods are discussed in the following embodiments.

### First Embodiment: Method of Determining a PUCCH Transmission Location in the Frequency Domain, Based on a Defined Region

A UE may follow a pre-arranged definition to determine a PUCCH transmission location in the frequency domain.

Referring to FIG. 14, in an SBFD environment, a UL subband 1405 and a DL subband 1410 may co-exist in the same time resource. In addition, there may be a UL region 1415 for UL transmissions only. Here, the UE needs to determine an appropriate frequency domain transmission location to transmit a PUCCH that does not overlap a DL subband and supports frequency hopping. To this end, methods in which the UE determines a PUCCH transmission location in the frequency domain are described in detail. At least one combination of the methods suggested below may be used.

### [Method 1-1. Method of, Based on UL BWP, Determining a PUCCH Transmission Location]

The UE may, based on a UL BWP, determine a PUCCH transmission location in the frequency domain. The base station may include the initial UL BWP information in the SIB1. The UE in the initial access stage may determine the PUCCH transmission location, based on the UL BWP information included in SIB1. The UE may determine whether the size of the configured UL BWP is larger or smaller than the size of the UL subband. For example, if the configured UL BWP is narrower than the UL subband, the UE may transmit a PUCCH only in the region where only UL transmission is possible (e.g., UL only region) and may not transmit PUCCH in the UL subband region. In this case, the reason for not transmitting in the UL subband is that the UL BWP is wider than the UL subband, and if the PUCCH is transmitted in the corresponding region, there may be a concern that the PUCCH is transmitted in the DL subband. In another example, if the configured UL BWP is narrower than the UL subband, the UE may be able to transmit a PUCCH in both the UL subband and the region where only UL transmission is possible. Therefore, with respect to determining the PUCCH transmission location based on the UL BWP, the UE may determine the transmission location according to the size of the UL BWP.

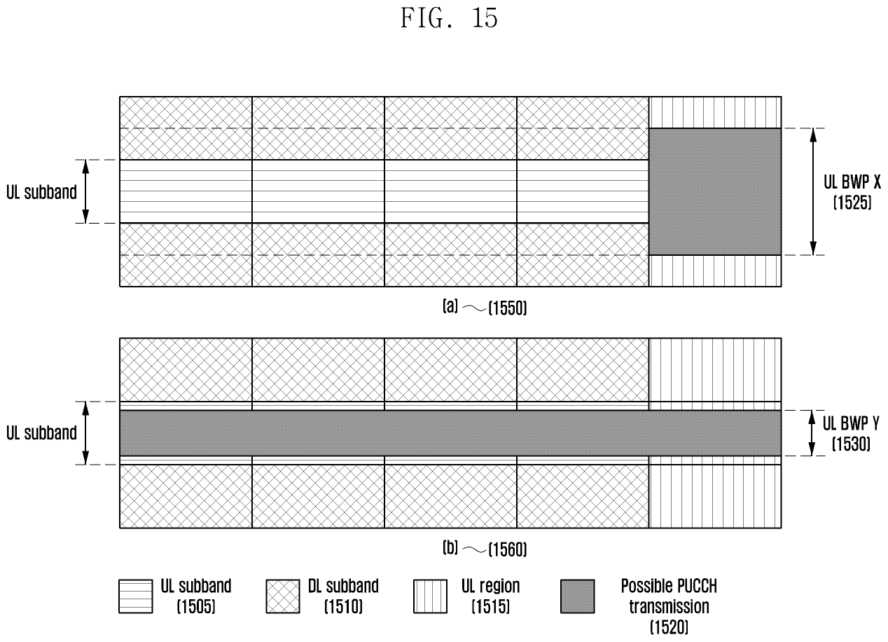

FIG. 15 illustrates an example of a method of, based on a UL BWP, determining a PUCCH transmission location. In an example, a base station may configure, in a UE, a UL BWP X 1525 that is wider than a UL subband 1505, as indicated by reference numeral 1550. In this case, based on the UL BWP, the UE may first determine a region in which transmission is possible. Since the configured UL BWP X 1525 has a wider frequency band than the UL subband 1405, the UE may determine that transmission of the corresponding PUCCH is possible within a UL region 1515 only (indicated by reference numeral 1520). Therefore, based on the UL BWP X 1525 configured in the UL region 1515, the UE may determine a PUCCH transmission location according to frequency hopping.

As another example, the base station may configure, in the UE, a UL BWP Y 1530 that is narrower than the UL subband 1505, as indicated by reference numeral 1560. In this case, based on the UL BWP, the UE may first determine a region in which transmission is possible. Since the configured UL BWP Y 1530 occupies a narrower band than the UL subband 1505, the UE may determine that transmission of the corresponding PUCCH is possible in the UL subband 1505 and the UL region 1515 (indicated by reference numeral 1520). Therefore, based on the UL BWP Y 1530 configured in the UL subband 1505 and UL region 1515, the UE may determine a PUCCH transmission location according to frequency hopping.

### [Method 1-2. Method of, Based on UL Subband, Determining a PUCCH Transmission Location in a Frequency Domain]

The UE may, based on a UL subband, determine a PUCCH transmission location in the frequency domain. The base station may include initial UL BWP information in the SIB1. The UE in the initial access stage may compare the UL BWP information included in SIB1 with the UL subband to determine the PUCCH transmission location. The UE may determine whether the size of the UL subband is larger or smaller than the size of the configured UL BWP. For example, if the UL subband is narrower than the UL BWP configured by the base station, the UE may be able to transmit a PUCCH in both the UL subband region and a region in which only UL transmission is possible (e.g., UL only region). As another example, if the UL subband is larger than the configured UL BWP, the UE may not be able to determine the PUCCH transmission location in all regions. This is because the criterion of transmitting PUCCH at both ends of the UL subband conflicts with the criterion of transmitting PUCCH within the UL BWP. Therefore, it may be necessary to configure a UL BWP to be wider than the UL subband to determine the PUCCH transmission location in the frequency domain using the above method.

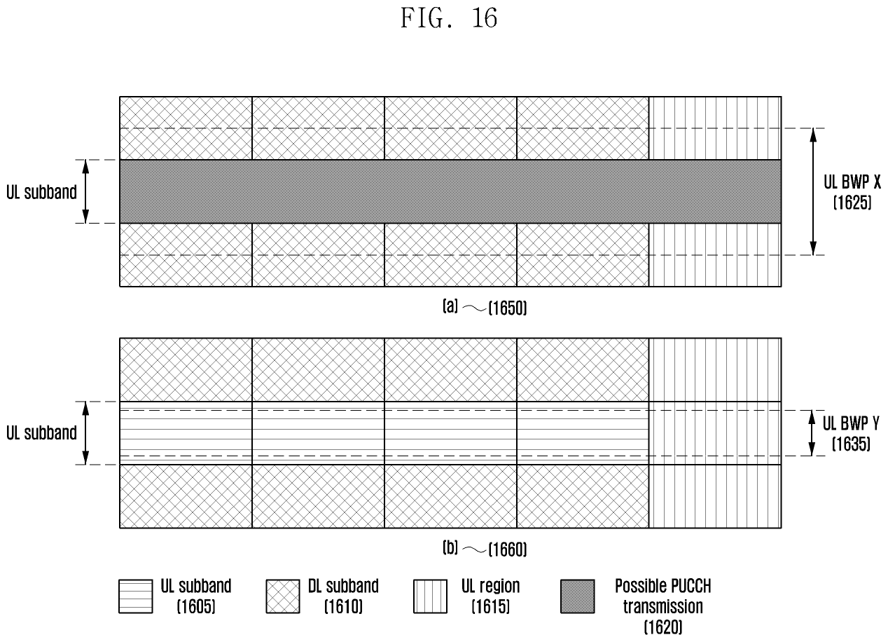

FIG. 16 illustrates an example of a method of, based on a UL subband, determining a PUCCH transmission location. In an example, a base station may configure, in the UE, a UL BWP X 1625 that is wider than a UL subband 1605, as indicated by reference numeral 1650. In this case, based on the size of the UL subband, the UE may determine a region in which transmission is possible. Since the configured UL BWP X 1625 occupies a wider band than the UL subband 1605, the UE may determine that the corresponding PUCCH is transmissible in both a UL region 1615 and the UL subband 1605, as indicated by reference numeral 1620. Therefore, the UE may determine a PUCCH transmission location according to frequency hopping in the UL region 1615 and the UL subband 1605.

In another example, the base station may configure, in the UE, a UL BWP Y 1635 that is smaller than the UL subband 1605, as indicated by reference numeral 1660. In this case, based on the UL subband, the UE determines a region in which transmission is possible and in this case, the transmission region should exist within the UL BWP. Since the configured UL BWP Y 1635 occupies a narrower band than the UL subband 1605, the UE may determine that transmission of the PUCCH is not possible in the UL subband 1605 and the UL region 1615.

### [Method 1-3. Method of Determining a PUCCH Transmission Location in a Frequency Domain, Based on a Permissible Region for a UL BWP or UL Subband]

The UE may determine the PUCCH transmission location in the frequency domain based on a narrower bandwidth among the UL subband or UL BWP. The base station may include initial UL BWP information in SIB1. The UE in the initial access stage may determine the PUCCH transmission location by comparing the UL BWP information included in SIB1 and the UL subband. If the UE compares the UL BWP and the UL subband and, as a result of the comparison, the UL BWP has a narrower bandwidth, the UE may, based on the UL BWP, determine the PUCCH transmission location. If the UE compares the UL BPW and the UL subband and, as a result of the comparison, the UL subband has a narrower bandwidth, the UE may, based on the UL subband, determine the PUCCH transmission location. This method allows the UE to determine the PUCCH transmission location without the PUCCH transmission encroaching on the DL subband and without a region in which transmission is not possible.

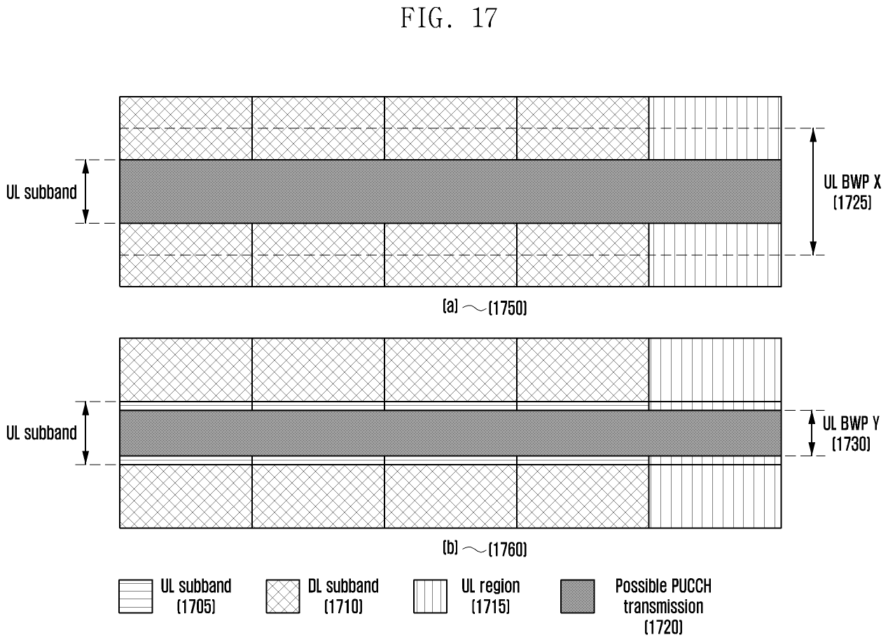

FIG. 17 illustrates an example of a method of determining a PUCCH transmission location in a region occupying a narrower bandwidth among a UL subband and a UL BWP. In an example, a base station may configure a UL BWP X 1725 in a UE, as indicated by reference numeral 1750. The UE may compare the size of the configured UL BWP X 1725 with the bandwidth size of the UL subband 1705. In this case, if the bandwidth of the UL subband 1705 is narrower than the UL BWP X 1725, the UE may, based on the UL subband 1705, determine a PUCCH transmission location. In another example, the base station may configure a UL BWP Y 1730 for the UE, as indicated by reference numeral 1760. The UE may compare the size of the configured UL BWP Y 1730 with the bandwidth size of the UL subband 1705. If the bandwidth of the UL subband 1705 is wider than the UL BWP Y 1730, the UE may, based on the UL BWP Y 1730, determine the PUCCH transmission location. By this method, the UE may determine the PUCCH transmission location in all regions (e.g., the UL subband 1705 region and the UL region 1715) without a region in which transmission is not possible and perform PUCCH transmission according to frequency hopping.

### [Method 1-4. Method of Determining a Transmission Location in an Overlap Region]

The UE may determine a PUCCH transmission location in a region in which PUCCH transmissions overlap. The base station may include initial UL BWP information in SIB1. Based on the UL BWP information included in the SIB1 and a location in a time domain in which transmission is possible, the UE in the initial access stage may determine a PUCCH transmission location. In an example, the transmission of the PUCCH for Msg 4 by the UE at the initial access may overlap in the UL subband region and in the time domain. In this case, based on the UL subband, the UE may determine a PUCCH transmission location according to frequency hopping.

As another example, the transmission of the PUCCH for Msg 4 by the UE at the initial access may overlap in the UL domain and in the time domain. In this case, based on the UL BWP in the UL domain, the UE may determine a PUCCH transmission location according to frequency hopping. To support this determination, when configuring the UL BWP, the base station may configure the UL BWP to have a wider bandwidth than the UL subband.

### Second Embodiment: Method of Determining a PUCCH Transmission Location in the Frequency Domain, Based on a Region Configured by a Base Station

In order to transmit the PUCCH, a UE in an initial access stage may receive a configuration of a region, in which transmission is possible, from the base station. Unlike the method described in the first embodiment, which determines the PUCCH transmission location according to a predefined rule, the base station may preconfigure a PUCCH transmission-capable region. In the following, a method in which the base station configures a PUCCH transmission-capable region is described in detail. At least one combination of the methods suggested below may be used.

### [Method 2-1. Method of, Based on a Higher Layer Configuration Signal, Determining a PUCCH Transmission Location in a Frequency Domain]

The base station may configure a PUCCH transmission-capable region for the UE. The PUCCH transmission-capable region may be configured based on a UL BWP, or may be configured based on a UL subband. The PUCCH transmission-capable region configuration information may be included in the SIB1. The UE that has received the SIB1 including the PUCCH transmission-capable region configuration information from the base station may determine the PUCCH transmission location, based on the PUCCH transmission-capable region configuration information. The PUCCH transmission-capable region may be configured in the same manner as the method of configuring a frequency resource (start and end points in the frequency domain, or SLIV format). Alternatively, the PUCCH transmission-capable region may be configured in the form of an offset value for the UL BWP configured in the SIB1. A combination of at least one of the following methods may be used, and a method to be used may be predetermined or determined by higher layer signaling or the like.

### [Method 2-1-1. Method of, Based on UL BWP, Determining a PUCCH Transmission Location in the Frequency Domain]

The base station may, based on the UL BWP, configure a PUCCH transmission-capable region for the UE.

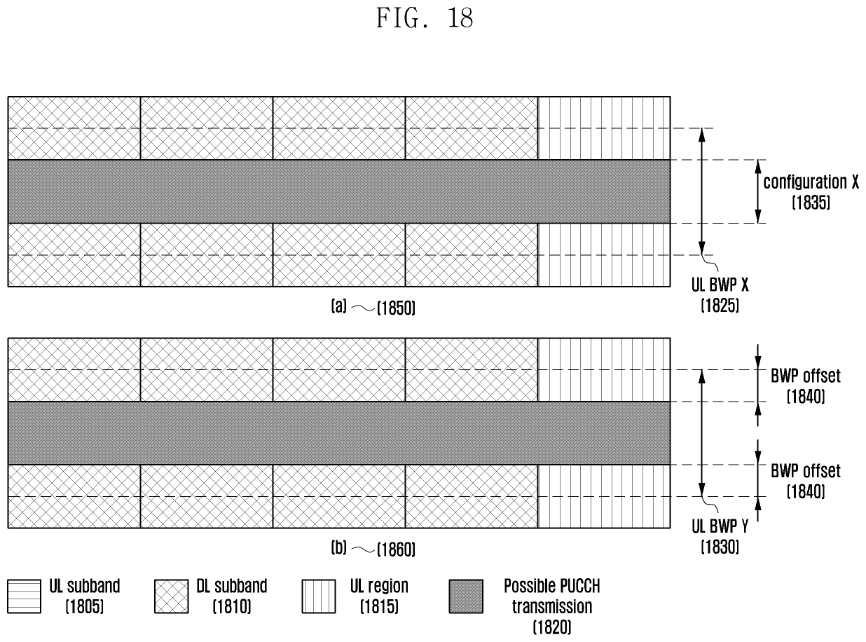

FIG. 18 illustrates an example of a method of, based on configuration information, determining a PUCCH transmission-capable region. According to reference numeral 1850, the base station may configure a resource PUCCH transmission-capable region (hereinafter, referred to as configuration X) 1835 for the UE. If the UE identifies PUCCH transmission-capable region configuration information included in SIB1, the UE may determine a location in which PUCCH transmission occurs in the corresponding region. In this case, the configuration X 1835 may be included in a UL BWP X 1825. The configuration X 1835 may indicate RBs belonging to the configuration X 1835 in the same manner as the method of configuring the frequency resources (start and end points in the frequency domain, or SLIV format), or may be indicated in a manner of dividing the UL BWP (or DL BWP for which some resources are converted to uplink resources) by a specific number of subbands and then indicating a specific subband. In this case, the number of subbands and the format of a bitmap indicating a subband belonging to the configuration X 1835 may be configured for the UE.

In another example, according to reference numeral 1860, the PUCCH transmission-capable configuration information may be an offset value for the UL BWP. If the UE identifies the PUCCH transmission-capable region configuration information included in SIB1, the UE may know that the PUCCH transmission location can be determined in the resource region, to which the offset value is applied, in the UL BWP. In addition, the corresponding PUCCH transmission-capable region may be determined as a region distant by a configured BWP offset 1840 at the lowest and highest frequencies (or the lowest RB index and the highest RB index) of a configured UL BWP Y 1830. Based on this determination, the UE may determine a PUCCH transmission location. The BWP offset 1840 may be configured as an offset at the lowest frequency and an offset at the highest frequency, may be applied with the same value of an offset, may be applied to either the lowest frequency or the highest frequency only, and may be configured in RB units or a specific number of RB units. In addition, the specific number of RB units may be predetermined or may vary depending on the number of RBs in the UL BWP (or DL BWP).

### [Method 2-1-2. Method of, Based on a UL Subband, Determining a PUCCH Transmission Location in a Frequency Domain]

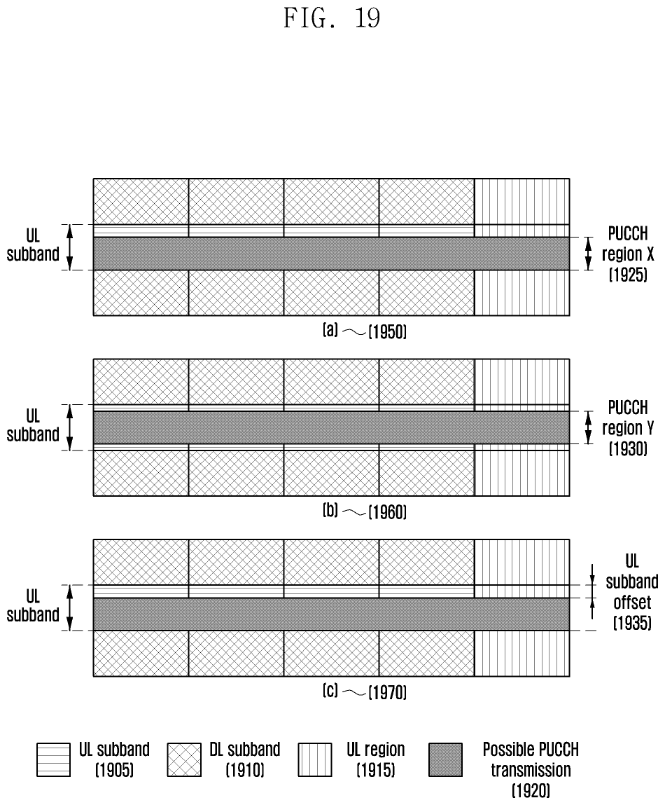

The base station may, based on a UL subband, configure a PUCCH transmission-capable region for the UE. FIG. 19 illustrates an example of a method of determining a PUCCH transmission-capable region, based on configuration information. According to reference numerals 1950 and 1960, the base station may configure a PUCCH transmission-capable region for the UE. In this case, the PUCCH transmission-capable region may be configured based on the UL subband. For example, the PUCCH transmission-capable region may be a PUCCH region X 1925 or a PUCCH region Y 1930. The PUCCH transmission-capable region configuration information may be information that indicates RBs belong to the PUCCH region X 1925 or PUCCH region Y 1930, based on a method of configuring the frequency resources (start and end points in the frequency domain, or SLIV format). Alternatively, the PUCCH transmission-capable region configuration information may be indicated in a manner of dividing the UL subband by a specific number of subbands and then indicating a specific subband. In this case, the number of subbands and the format of a bitmap indicating a subband belonging to the PUCCH region X 1925 among the subbands may be configured for the UE. If the UE identifies the PUCCH transmission-capable region configuration information in SIB1, the UE may know that the PUCCH transmission location may be determined in the corresponding region within the UL subband.

In another example, the PUCCH transmission-capable region configuration information may be an offset value for the UL subband. If the UE identifies the PUCCH transmission-capable region configuration information included in the SIB1, the UE may know that the PUCCH transmission location can be determined in the corresponding region. In addition, the corresponding PUCCH transmission-capable region may be determined as a region distant by a configured UL subband offset 1935 at the lowest and highest frequencies (or the lowest RB index and the highest RB index) of a configured UL subband 1905. Based on this determination, the UE may determine the PUCCH transmission location. The UL subband offset 1935 may be configured as an offset at the lowest frequency and an offset at the highest frequency, or may be applied with the same value of an offset, may be applied to either the lowest frequency or the highest frequency only, and may be configured in RB units or a specific number of RB units. In addition, the specific number of RB units may be predetermined or may vary depending on the number of RBs in the UL subband 1905.

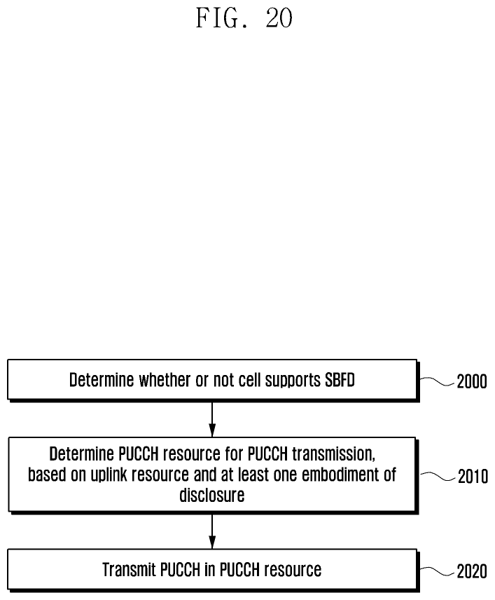

FIG. 20 illustrates an example of a UE operation according to an embodiment of the disclosure.

In operation 2000, an SBFD-supporting UE may determine that the cell (or base station) supports SBFD. This determination may be based on at least one of a frequency band, system information, higher layer signaling, etc. according to the methods described above. Although not shown, the SBFD-supporting UE may report its own UE capability to the base station. The UE capability information may include at least one of the pieces of information described above.

In operation 2010, the SBFD-supporting UE may determine that some downlink resources are configured as uplink resources. The determination may be possible via higher layer signaling, L1 signaling (DCI), etc. The UE may determine a UL subband, a UL BWP, and a UL region. Thereafter, the SBFD UE determines a PUCCH resource for PUCCH transmission. The determination of the PUCCH resource may be possible through a combination of a part of the first embodiment described above or a part of the second embodiment described above, and may be made based on configuration information for the PUCCH resource in the base station. In operation 2020, the UE transmits the PUCCH on the determined PUCCH resource.

The operations described above may be performed in a different order or with some of the operations being omitted or added.

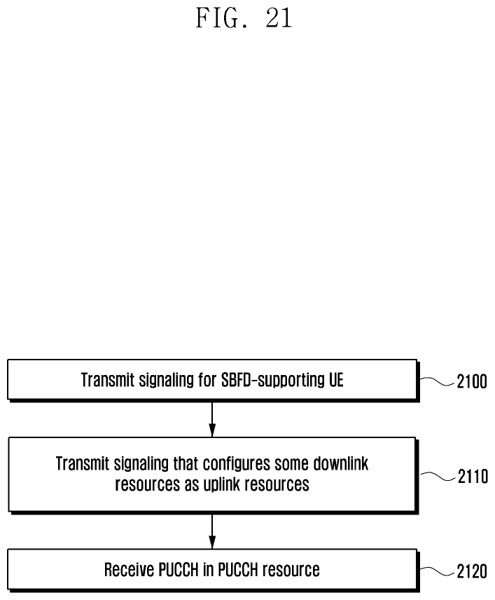

FIG. 21 illustrates an example of a base station operation according to an embodiment of the disclosure.

In operation 2100, the base station may perform signaling for an SBFD-supporting UE. The signaling may include information about whether SBFD is supported, random access resource information for the SBFD-supporting UE, system information for SBFD support, and the like. In addition, although not shown, the base station may receive UE capability information from the SBFD-support UE. The UE capability information may include at least one of the pieces of information described above.

In operation 2110, the base station may transmit, to the SBFD-support UE, configuration information indicating that some downlink resources are configured as uplink resources. This configuration information may be transmitted via higher layer signaling, L1 signaling (DCI), or the like. Thereafter, in operation 2120, the base station may receive a PUCCH in a PUCCH resource considering at least one of a UL subband, a UL BWP, and a UL region. The PUCCH resource may be configured according to a combination of a part of the first embodiment described above or a part of the second embodiment described above, and the base station may transmit configuration information for the PUCCH resource according to embodiments of the disclosure.

The operations described above may be performed in a different order or with some of the operations being omitted or added.

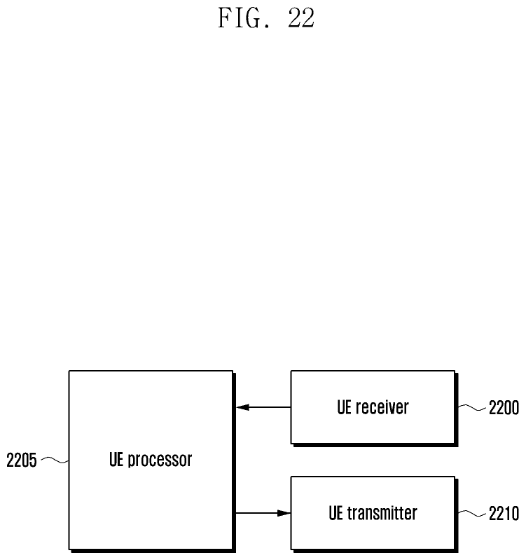

FIG. 22 illustrates a structure of a UE in a wireless communication system according to an embodiment of the disclosure.

Referring to FIG. 22, the UE may include a transceiver, which refers to a UE receiver 2200 and a UE transmitter 2210 as a whole, a memory (not illustrated), and a UE processor 2205 (or UE controller or processor). The UE transceiver 2200 and 2210, the memory, and the UE processor 2205 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

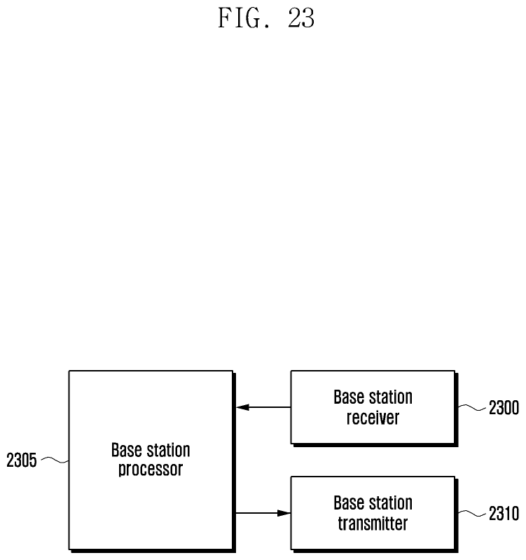

FIG. 23 illustrates a structure of a base station in a wireless communication system according to an embodiment of the disclosure.

Referring to FIG. 23, the base station may include a transceiver, which refers to a base station receiver 2300 and a base station transmitter 2310 as a whole, a memory (not illustrated), and a base station processor 2305 (or base station controller or processor). The base station transceiver 2300 and 2310, the memory, and the base station processor 2305 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a terminal in a wireless communication system, the method comprising:
receiving subband non-overlapping full duplex (SBFD) configuration information from a base station, the SBFD configuration information including uplink subband configuration information;
identifying a physical uplink control channel (PUCCH) resource, based on an uplink subband, which is based on the uplink subband configuration information, and an initial uplink bandwidth part (BWP); and
transmitting uplink control information in the PUCCH resource.

2. The method of claim 1, wherein the PUCCH resource is identified based on a resource in which the uplink subband and the initial uplink BWP overlap.

3. The method of claim 1, wherein the SBFD configuration information includes resource region information for the PUCCH resource, and the resource region information includes offset information associated with the uplink subband or the initial uplink BWP.

4. The method of claim 1,
wherein the PUCCH resource includes a first resource and a second resource included in a PUCCH transmission-capable resource determined based on the uplink subband and the initial uplink BWP, and
wherein the first resource and the second resource are identified via a frequency hopping configuration.

5. A method performed by a base station in a wireless communication system, the method comprising:
receiving subband non-overlapping full duplex (SBFD) configuration information from a terminal, the SBFD configuration information including uplink subband configuration information; and
receiving uplink control information in a physical uplink control channel (PUCCH) resource,
wherein the PUCCH resource is associated with an initial uplink bandwidth part (BWP) and an uplink subband according to the uplink subband configuration information.

6. The method of claim 5, wherein the PUCCH resource is based on a resource in which the uplink subband and the initial uplink BWP overlap.

7. The method of claim 5, wherein the SBFD configuration information includes resource region information for the PUCCH resource, and the resource region information includes offset information associated with the uplink subband or the initial uplink BWP.

8. The method of claim 5,
wherein the PUCCH resource includes a first resource and a second resource included in a PUCCH transmission-capable resource determined based on the uplink subband and the initial uplink BWP, and
wherein the first resource and the second resource are associated with frequency hopping.

9. A terminal in a wireless communication system, the terminal comprising:
a transceiver; and
a controller configured to:
receive subband non-overlapping full duplex (SBFD) configuration information from a base station, the SBFD configuration information including uplink subband configuration information,
identify a physical uplink control channel (PUCCH) resource, based on an uplink subband, which is based on the uplink subband configuration information, and an initial uplink bandwidth part (BWP), and
transmit uplink control information in the PUCCH resource.

10. The terminal of claim 9, wherein the PUCCH resource is identified based on a resource in which the uplink subband and the initial uplink BWP overlap.

11. The terminal of claim 9, wherein the SBFD configuration information includes resource region information for the PUCCH resource, and the resource region information includes offset information associated with the uplink subband or the initial uplink BWP.

12. The terminal of claim 9,
wherein the PUCCH resource includes a first resource and a second resource included in a PUCCH transmission-capable resource determined based on the uplink subband and the initial uplink BWP, and
wherein the first resource and the second resource are identified via a frequency hopping configuration.

13. A base station in a wireless communication system, the base station comprising:
a transceiver; and
a controller configured to:
receive subband non-overlapping full duplex (SBFD) configuration information from a terminal, the SBFD configuration information including uplink subband configuration information, and
receive uplink control information in a physical uplink control channel (PUCCH) resource,
wherein the PUCCH resource is associated with an initial uplink bandwidth part (BWP) and an uplink subband according to the uplink subband configuration information.

14. The base station of claim 13, wherein the PUCCH resource is based on a resource in which the uplink subband and the initial uplink BWP overlap.

15. The base station of claim 13, wherein the SBFD configuration information includes resource region information for the PUCCH resource, and the resource region information includes offset information associated with the uplink subband or the initial uplink BWP.
